(19) United States
(12) Patent Application Publication
(10) Pub. No.: US 2010/0296481 A1
(43) Pub. Date: Nov. 25, 2010

(54) METHODS IN MIXED NETWORK- AND HOST-BASED MOBILITY MANAGEMENT

(75) Inventors: Kilian Weniger, Langen (DE); Genadi Velev, Langen (DE); Jens Luis Bachmann, Langen (DE); Jon Schuringa, Langen (DE)

Correspondence Address: Dickinson Wright PLLC;James E. Ledbetter, Esq., International Square, 1875 Eye Street, N.W., Suite 1200, Washington, DC, 20006, US

(73) Assignee: Panasonic Corporation, Osaka (JP)

(21) Appl. No.: 12/446,192

(22) PCT Filed: Oct. 19, 2007
(86) PCT No.: PCT/EP07/09112

§ 371 Date: Jun. 11, 2009

(30) Foreign Application Priority Data
Oct. 20, 2006 (EP) 06022076.1
Jan. 30, 2007 (EP) 07001999.7
Feb. 14, 2007 (EP) 07003166.1
May 16, 2007 (EP) 07009852.0

(51) Int. Cl. H04W 36/00; H04W 8/00

(52) U.S. Cl. 370/331; 370/328

(57) ABSTRACT

A first aspect of the invention relates to a method for improving security at a local mobility anchor implementing both a network-based and a host-based mobility management scheme for managing the mobility of a mobile node. It suggests a method for verifying an attachment of a mobile node (MN) to a network element in a network. A second aspect of the invention relates to a method to be implemented in a mobility anchor node, which detects whether a race condition between registration messages occurs and resolves the most recent location of a mobile node. A third aspect of the invention relates to a method for detecting whether a binding cache entry for a mobile at a correspondent node has been spoofed and to a method for registering a care-of address of a mobile node at a correspondent node.

### FIELD OF THE INVENTION

The invention relates, according to a first aspect, to the mobility management of a mobile node in packet-based communication networks, and more specifically, to a method for improving security at a local mobility anchor implementing both a network-based and a host-based mobility management scheme for managing the mobility of a mobile node.

The invention relates to a method for detecting an attempt from a compromised network element to redirect traffic destined to a mobile node. It suggests a method for verifying an attachment of a mobile node to a network element in a network. It also provides a local mobility anchor, a mobile node and a network element that participate in this method.

The invention relates, according to a second aspect, to inter-working of network-based and host-based mobility management in packet-based communication networks. It provides a method to resolve a race condition at a mobility anchor point in mixed network-based and host-based mobility management, and to ensure that a mobility anchor point, upon receiving two binding updates, always accepts the most recent binding update.

The invention relates, according to a third aspect, to a method for detecting whether a binding cache entry for a mobile node at a correspondent node has been spoofed. Further, the third aspect of the invention also relates to a method for registering a care-of address of a mobile node at a correspondent node. The third aspect of the invention also provides a mobile node and a correspondent node that participate in these methods and a mobile communication system comprising the mobile node and the correspondent node.

### TECHNICAL BACKGROUND

Mobile communication systems evolve more and more towards an Internet Protocol (IP)-based network. The Internet consist of many interconnected networks, in which speech and data is transmitted from one terminal to another terminal in pieces, so-called packets. Those packets are routed to the destination by routers in a connection-less manner. Therefore, packets consist of IP header and payload information and the header comprises among other things source and destination IP address. For scalability reasons, a large IP network is usually divided in subnets and uses a hierarchical addressing scheme. Hence, an IP address does not only identify the corresponding terminal, but additionally contains location information (current subnet) about this terminal. With additional information provided by routing protocols, routers in the network are able to identify the next router towards a specific destination.

If a terminal is mobile, from now on called Mobile Node (MN), and moves between subnets, it must change its IP address to a topologically correct one because of the hierarchical addressing scheme. However, since connections on higher-layers such as TCP connections are defined with the IP addresses (and ports) of the communicating nodes, the connection breaks if one of the nodes changes its IP address, e.g., due to movement.

Mobile IPv6 (see D. Johnson, C. Perkins, J. Arkko, “Mobility Support in IPv6”, IETF RFC 3775, June 2004 available at http://www.ietf.org and incorporated herein by reference) is an IP-based mobility protocol that enables mobile nodes to move between subnets in a manner transparent for higher layers and applications, i.e. without breaking higher-layer connections. Therefore, a mobile node has two IP addresses configured: a Care-of-Address (CoA) and a Home Address (HoA). The mobile node's higher layers use the home address for communication with the communication partner, who is associated with the destination terminal, from now on called Corresponding Node (CN). This address does not change and serves the purpose of identification of the mobile node. Topologically, it belongs to the Home Network (HN) of the mobile node. In contrast, the Care-of-Address changes on every movement that results in a subnet change and is used as the locator for the routing infrastructure. Topologically, it belongs to the network the mobile node is currently attached to. One out of a set of Home Agents (HA) located on the home link maintains a mapping of the mobile node's Care-of-Address to the mobile node's Home Address and redirects incoming traffic for the mobile node to its current location. Reasons for having a set of home agents instead of a single HA are redundancy and load balancing.

Mobile IPv6 currently defines two modes of operation: bi-directional tunneling and route optimization. FIG. 1 exemplifies the use of bi-directional tunneling. Data packets sent by the correspondent node and addressed to the home address of the mobile node are intercepted by the home agent in the home network and tunneled to care-of address of the mobile node. Data packets sent by the mobile node are reverse tunneled to the home agent, which decapsulates the packets and sends them to the correspondent node (reverse tunneling means that packets are transmitted by the mobile node via a tunnel that starts at the mobile node's care-of address and terminates at the home agent).

For this operation, only the home agent is informed about the care-of address of the mobile node. Therefore, the mobile node sends Binding Update (BU) messages to the home agent. The binding update messages are sent over an IPsec security association and thus are cryptographically protected to provide data origin authentication and integrity protection. This requires that the mobile node and the home agent share a secret key. Hence, the home agent only accepts binding update messages for the mobile node's home address, which are cryptographically protected with the corresponding shared key.

A drawback is that if the mobile node is far away from the home network and the correspondent node is close to the mobile node, the communication path is unnecessarily long, resulting in inefficient routing and high packet delays. The route optimization mode can prevent the inefficiency of bi-directional tunneling mode by using the direct path between correspondent node and mobile node. The mobile node sends binding update messages to the correspondent node, which then is able to directly send data packets to the mobile node (a type 2 routing header is used to send the packets on the direct path). Of course, the correspondent node has to implement Mobile IPv6 route optimization support

To authenticate the binding update message to the correspondent node, the mobile node and the correspondent node perform a so-called return routability procedure, which tests the reachability of the mobile node at the home address and care-of address using a home address test and a care-of address test, respectively, and generates a shared session key. Subsequently, the mobile node may register its care-of address at the correspondent node utilizing the session key for authenticating its binding update sent to the correspondent node.

Mobile IP is a host- or client-based protocol, since the mobility management signalling is between the host/client and the home agent. Hence, Mobile IP is also sometimes called Client Mobile IP (CMIP). Another approach becoming popular is a network-based approach for IP mobility management, i.e., an entity in the visited access network manages the mobility for the mobile node and signals location updates to the home agent. Network-based mobility management has some advantages like less signalling overhead over the air and mobility support for simple IP nodes (i.e., non-CMIP-capable nodes). The drawback is that it requires support from the visited access network.

The IETF is working on such approach for localized mobility management based on the Mobile IP protocol. Since a network entity is acting as a proxy on behalf of the mobile node, the protocol is called Proxy Mobile IP (PMIP). There are variants for IPv6 called PMIPv6 (see e.g. S. Gundavelli, K. Leung, V. Devarapalli, K. Chowdhury, B. Patil, Proxy Mobile IPv6, draft-sgundave-mip6-proxymip6-02, March 2007) and variants for IPv4 called PMIPv4 (see e.g. K. Leung, G. Dommety, P. Yegani, K. Chowdhury, “Mobility Management using Proxy Mobile IPv4”, draft-leung-mip4-proxy-mode-02.txt, January 2007).

PMIPv6 introduces a new logical entity called Proxy Mobile Agent (PMA) or Mobile Access Gateway (MAG), which is typically co-located with the Access Router (AR) the mobile node is currently attached to and which sends Binding Update (BU) messages on behalf of the mobile node. The PMIP home agent is an extended CMIP home agent and is called Local Mobility Anchor (LMA). Binding update messages sent by the Mobile Access Gateway are marked with a flag, so that they can be identified as Proxy Binding update (PBU) messages by the Local Mobility Anchor and distinguished from Binding update messages sent by the mobile node (i.e. CMIP signaling messages).

Furthermore, PBU messages contain a Network Access Identifier (NAI) option, a home prefix option, and a timestamp option. The NAI option contains the Network Access Identifier [RFC4282] of the mobile node, which has a form such as “username@realm” and which is used to identify the mobile node. The home prefix option contains the home address or home prefix of the mobile node. Two addressing models are supported by PMIPv6: In the so-called per-MN-prefix model, every mobile node has a unique home prefix, which can be used in the PBU messages instead of a home address. In the shared prefix model, a mobile node uses a home address from a prefix, which is shared between multiple mobile nodes. The timestamp option contains the time the PBU has been sent and is used by the Local Mobility Anchor to identify the “freshness” of a PBU and correct the ordering of PBU messages. The sequence number value in the PBU message is not used by PMIPv6 and is ignored by the Local Mobility Anchor. The sequence number value of the PBU message is not considered by the Home Agent for determining the sequence of PBUs because the PMAs do not synchronize the sequence number they use for the PBUs.

When a mobile node attaches to a new Mobile Access Gateway after a handover or after being powered on, it authenticates with the network, e.g. using a link-layer specific method, the EAP framework (see RFC3748), and an EAP method such as EAP-AKA (see RFC4187). The Mobile Access Gateway typically acts as pass-through authenticator and forwards the EAP packets to a backend authentication server, such as a AAA server or infrastructure, e.g. using a AAA protocol such as Diameter (see RFC3588, RFC4072) or Radius (see RFC2865, RFC3579). The mobile node uses e.g. a Network Access Identifier as identifier during network authentication. If the network authentication is successful, the Mobile Access Gateway obtains the mobile node's profile from the AAA server including the mobile node's home prefix and stores the profile together with the Network Access Identifier. The Mobile Access Gateway then sends a PBU to the Local Mobility Anchor to register the mobile node's new location. The PBU sending process can be triggered, e.g. by a successful network authentication, by DHCP (Dynamic Host Configuration Protocol) messages or others. Further, the Mobile Access Gateway announces the mobile node's home prefix to the mobile node. Consequently, the mobile node thinks it is at home as long as it moves within the set of Mobile Access Gateways announcing the mobile node's home prefix and managing the mobility of the mobile node (henceforth called PMIPv6 or PMIP domain) and it does not notice that it changes subnets. A tunnel between the Local Mobile Anchor and the Mobile Access Gateway is established and all traffic from and to the mobile node is forwarded through this tunnel.

The proxy binding update messages are sent over an IPsec security association and thus are cryptographically protected to provide data origin authentication and integrity protection. This typically requires that a mobile access gateway and a home agent share a secret key. Hence, the home agent only accepts proxy binding update messages PBU for a mobile access gateway's address, which is cryptographically protected with the corresponding shared key. Since the Local Mobility Anchor accepts basically any PBU message that is sent by a trusted Mobile Access Gateway, which owns a correct shared key, a problem arises if a Mobile Access Gateway gets compromised, i.e. if an attacker is able to gain control of a trusted Mobile Access Gateway. In this case, this Mobile Access Gateway can mount off-path attacks by sending a bogus PBU to the Local Mobile Anchor and redirect the traffic for any mobile node in the PMIP domain to itself. The problem is even more severe, if the Local Mobility Anchor is also the CMIP anchor of a mobile node and the PMIP-Home Address is equal to the CMIP-Home Address. In this case, the attack is extended to MIPv6 and the attacker can redirect traffic for mobile nodes that are located outside the PMIP domain.

This situation is illustrated in FIG. 1. A mobile node (MN), which exchanges data packets with a correspondent node (CN), is located outside its home PMIP domain and uses the Local Mobility Anchor (LMA) as Home Agent for MIPv6. When the mobile node is in the PMIP domain, it may be served by a Mobile Access Gateway MAG1. However, a compromised Mobile Access Gateway MAG2 can send a bogus PBU for the mobile node's Home Address. The Local Mobile Anchor accepts this bogus PBU thinking that the mobile node has moved to the Mobile Access Gateway MAG2. Thus, it forwards all incoming traffic for the mobile node to the Mobile Access Gateway MAG2.

Hence, two types of redirection attacks can be distinguished, depending on the position of a mobile node. Firstly, redirection attacks can be directed against mobile nodes that are located in the same PMIPv6 domain than the compromised Mobile Access Gateway (scenario 1). Secondly, redirection attacks can be directed against mobile nodes that are located outside the PMIPv6 domain of the compromised Mobile Access Gateway and that are using Mobile IPv6 (scenario 2).

Regarding scenario 1, the Local Mobile Anchor could check whether the Mobile Access Gateway is authorized to create a binding cache entry for mobile nodes (see S. Gundavelli, K. Leung, V. Devarapalli, K. Chowdhury, B. Patil, Proxy Mobile IPv6, draft-sgundave-mip6-proxymip6-02, March 2007). The details of this check are not described, but it is suggested that a policy store such as an AAA infrastructure can be queried. However, consulting the policy store or an AAA server for every received PBU message would significantly increase the handover delay.

Regarding scenario 2, S. Gundavelli, K. Leung, V. Devarapalli, K. Chowdhury, B. Patil, Proxy Mobile IPv6, draft-sgundave-mip6-proxymip6-02, March 2007 describes a mechanism that the Local Mobility Anchor, upon receiving a PBU message, does not change the binding cache entry before the de-registration BU message is received from the mobile node, if the current binding cache entry indicates that the mobile node is located outside the PMIP domain. Since the attacker cannot spoof a de-registration BU message, this mechanism would solve the problem. However, this mechanism also significantly increases the handover delay when a mobile node enters the PMIP domain and does not solve the problem in scenario 1.

When a Mobile node (MN) attaches to a new PMA, it authenticates with the network using the EAP framework [RFC3748] and an EAP method such as EAP-AKA [RFC4187]. The PMA typically acts as pass-through authenticator and forwards the EAP packets to the AAA server/infrastructure related to the MN. The MN uses a NAI as identifier. If the network authentication is successful, the PMA obtains the MN's profile from the AAA server including the MN's home prefix. The PMA then sends a PBU to the HA and announces the home prefix to the MN. After the MN authenticates with the AR, it starts the IP configuration, i.e. it configures a link-local (LL) IP address, performs Duplicate Address Detection (DAD) for the LL address sending a Neighbour Solicitation (NS) message to the solicited-node multicast address of the LL address to be checked. If the procedure is successful, the MN sends Router Solicitation (RS) message to all-routers multicast address and waits for receiving a Router Advertisement (RA). The AR/PMA responds with unicast RA including the MN's home prefix. In this invention, it is assumed that the MN applies statefull address configuration scheme, meaning that Dynamic Host Configuration Protocol (DHCP) is used. The MN learns that DHCP is to be used from the received unicast RA message, in which the “M” flag is set. Consequently, the MN sends DHCP solicit message, which is captured by the AR/PMA acting as DHCP relay agent. The DHCP relay forwards this message to the DHCP server, which answers with DHCP reply or advertise message including the MN's home address (HoA). After the MN receives the DHCP advertise message, the MN configures the advertised HoA as its global IP address. Consequently, the MN is reachable and thinks it is at home as long as it moves within the PMIP domain. An exemplary signalling flow for PMIPv6 during initial attachment procedure as described in this paragraph is shown in FIG. 6.

FIG. 7 shows the signalling flow in case of handover between PMAs within the same PMIP domain. When the MN moves to the area of AR/PMA 2, it starts the authentication procedure as described in FIG. 6. After the PMA2 receives the EAP keytransport message, it can start the registration process with HA sending PBU [NAI, home prefix, timestamp]. After the MN has successfully authenticated with PMA2, it starts checking if the current IP configuration is still valid, i.e. MN sends a RS message. AR/PMA2 responds with RA having “M” flag set for using DHCP for address configuration. Following, the MN sends DHCP confirm message, which is intercepted by the AP/PMA2 acting as DHCP relay entity. The DHCP reply message sent by the DHCP server confirms that the previously configured HoA can still be used. After the DHCP procedure is completed, the MN is again IP connected and can send/receive data packets.

The functionality of a HA for MIPv6 as defined in RFC3775 is re-used to a large extent, but some changes are necessary to support PMIPv6. Henceforth, a HA as defined in RFC3775 is called CMIP-HA and a HA as defined in (S. Gundavelli, K. Leung, V. Devarapalli, K. Chowdhury, “Proxy Mobile Ipv6”, draft.agundave-mip6-proxymip6-01, January 2007) is called PMIP-HA. For instance, a major difference is how the freshness of BU/PBU messages is determined by the HA. A CMIP-HA identifies the freshness of a BU message based on the sequence number in the BU, whereas a PMIP-HA identifies the freshness of a PBU messages based on the timestamp in the timestamp option in the PBU. A PMIP-HA does not consider the sequence number value in PBU messages.

A possible scenario containing co-located PMIP-HA and a CMIP-HA (further in the invention such CMIP/PMIP-HA is simply called HA) is shown on FIG. 8. In the figure, PMIPv6 is used for localized mobility management in the home operator network and CMIPv6 for global mobility management if the MN roams in other networks. The HA maintains a database where the MN's CoAs are registered. These registrations are based on the BU and PBU messages send correspondingly by MN or PMAs. This database is further called Binding Cache Entry (BCE).

The BU and PBU messages contain different CoAs, however, both are bound to the same HoA. If the HA does not implement a mechanism for separating different IP flows destined to the same HoA among different CoAs (such mechanism is known as multi-homing), the HA needs to have only one active binding of HoA and CoA, so that the HA unambiguously knows to which CoA the data packets are forwarded. Since the BU and PBU messages contain different CoAs, the HA needs to decide which message, correspondingly which CoA, is the current one.

As described above, the binding updates sent by the mobile node (in case of client-based mobility and called for simplicity CBU for client-BU) and proxy mobile agent (in case of network-based mobility and called for simplicity PBU for proxy-BU) are compared for freshness based on different conditions. The client binding update contains sequence number, which is increased each time a new binding update is sent. The proxy binding update contains a timestamp denoting the sending time in the receiver. Having this, the home agent cannot compare which of both binding updates is sent more recently. Further in this invention this situation is called binding update race condition because the home agent cannot conclude on the freshness of the binding update based on the consequence of binding update arrival, since the binding updates are propagated over different routes.

If re-ordering of the binding updates occurred and the home agent falsely accepts an older binding update, the data packets to the mobile node would be routed to the old mobile node's location, i.e. the packets would be lost. Scenarios, in which the BU and PBU arrive re-ordered in the HA are shown in FIG. 9 and FIG. 10. FIG. 9 shows a case where the MN moves from CMIP-based mobility to a PMIP-based mobility mechanism and where the BU sent by the MN arrives later in the HA than the PBU sent by the PMA. Analogically, FIG. 10 shows the transition from PMIP-based mobility to a CMIP-based mobility mechanism and where the PBU sent by the PMA arrives later in the HA than the BU sent by the MN.

Mobile IPv6 currently defines two modes of operation: bi-directional tunneling and route optimization. FIG. 15 exemplifies the use of bi-directional tunneling. Data packets sent by the correspondent node and addressed to the home address of the mobile node are intercepted by the home agent in the home network and tunneled to care-of address of the mobile node. Data packets sent by the mobile node are reverse tunneled to the home agent, which decapsulates the packets and sends them to the correspondent node (reverse tunneling means that packets are transmitted by the mobile node via a tunnel that starts at the mobile node's care-of address and terminates at the home agent).

For this operation, only the home agent is informed about the care-of address of the mobile node. Therefore, the mobile node sends Binding Update (BU) messages to the home agent. These messages are sent over an IPsec security association and thus are authenticated and integrity protected. A drawback is that if the mobile node is far away from the home network and the correspondent node is close to the mobile node, the communication path is unnecessarily long, resulting in inefficient routing and high packet delays.

The route optimization mode can prevent the inefficiency of bi-directional tunneling mode by using the direct path between correspondent node and mobile node. The use of route optimization is exemplified in FIG. 16. The mobile node sends binding update messages to the correspondent node, which then is able to directly send data packets to the mobile node (a type 2 routing header is used to send the packets on the direct path). Of course, the correspondent node has to implement Mobile IPv6 route optimization support.

To authenticate the binding update message, the mobile node and the correspondent node perform a so-called return routability procedure (see FIG. 17), which tests the reachability of the mobile node at the home address and care-of address using a home address test and a care-of address test, respectively, and generates a shared session key. Subsequently, the mobile node may register its care-of address at the correspondent node utilizing the session key for authenticating its binding update sent to the correspondent node.

As shown in FIG. 18, a mobile node initiates the return routability procedure by sending a home test init message, which is reverse tunneled over the home agent. The home test init message contains a cookie to be able to map replies to requests. The correspondent node replies with so-called home test messages which contain a home cookie, a home nonce index and a home keygen token. The home keygen token is calculated with a keyed hash function from the home address and the home nonce. In parallel or subsequent to this exchange, the mobile node sends a care-of test init message on the direct path to the correspondent node. The care-of test init contains the care-of cookie and correspondent node replies with a care-of test message, which contains the care-of cookie, a care-of nonce index and a care-of keygen token, which is calculated with a keyed hash function from the care-of address and the care-of nonce. The key for the hash function and the nonce are only known by correspondent node. After mobile node has received both home test and care-of test messages, it calculates a binding key “kbm”, which is the hash value of the concatenation of the keygen tokens in home test and care-of test messages. Next, the mobile node calculates an authenticator using a hash function keyed with the binding key. The authenticator is calculated over the binding update message, home address and care-of address and is appended to the binding update message. This authorized binding update message is finally sent to the correspondent node. If the verification is successful, correspondent node creates the binding of home address and care-of address in its binding cache and can send packets directly to mobile node's care-of address.

With respect to security, the design goal was to achieve a level comparable to IPv6, i.e., allow redirection of traffic only, if the attacker is on the path.

Multiple types of attacks against the return routability procedure and the route optimization mode are possible (see e.g. P. Nikander, J. Arkko, et al, “Mobile IP Version 6 Route Optimization Security Design Background”, IETF RFC 4225, December 2005, available at http://www.ietf.org and incorporated herein by reference). The two most important attacks which are possible if a bogus binding update message is falsely accepted by the correspondent node are
Address stealing or impersonation attack an attacker tries to redirect the traffic destined for a victim to himself in order to eavesdrop or tamper the traffic or to drop them for denial of service. The victim can be a mobile node or any stationary node with a globally routable address.
Flooding attack an attacker subscribes to a high-bandwidth service and redirects the incoming traffic to a victim for denial of service.

The following table gives an overview of possible combinations of addresses that an attacker could put in binding update messages, the consequences if the binding update is accepted by the correspondent node and possible countermeasures:

| 1) | home address = victim's home address/address, care-of | |
|---|---|---|
| | address = attacker's care-of address | |
| | Target: | Address stealing/Impersonation attack for |
| | | eavesdropping/tampering |
| | Countermeasures: | cryptographically generated address, home |
| | | address test |
| 2) | home address = victim's home address/address, care-of | |
| | address = non-existing care-of address | |
| | Target: | Address stealing/Impersonation attack for |
| | | denial of service |
| | Countermeasures: | cryptographically generated address, home |
| | | address test |
| 3) | home address = Attacker's home address, care-of address = | |
| | victim's care-of address | |
| | Target: | Flooding attack |
| | Countermeasures: | credit-based binding acknowledgement, |
| | | care-of address test |
| 4) | home address = Attacker's home address with victim's prefix, | |
| | care-of address = attacker's care-of address | |
| | Target: | Return-to-home flooding: attacker |
| | | subscribes home address to high-bandwidth |
| | | service and lets binding expire to |
| | | redirect steam to victim's network for |
| | | denial of service |
| | Countermeasures: | home address test |

Due to the home address test (home test/home test init exchange), an attacker must be reachable at the claimed home address. Hence, only attackers on the path between the home agent and the correspondent node and attackers between the mobile node and the home agent can successfully complete attacks with the address combinations no 1, 2, and 4. If IPsec is used, the home test in the tunnel between mobile node and home agent should be encrypted (see J. Arkko, V. Devarapalli, F. Dupont, “Using IPsec to Protect Mobile IPv6 Signaling Between Mobile Nodes and Home Agents”, IETF RFC 3776, June 2004, available at http://www.ietf.org and incorporated herein by reference). In this case, an attacker must be on the path between home agent and correspondent node to successfully complete attack with the address combination no 1, 2, and 4. Due to the care-of address test (care-of test/care-of test init exchange), the attacker must be reachable at the claimed care-of address in order to successfully complete a flooding attack with the address combination no 3.

In summary, the attacker must be on the path to be able to redirect traffic using a bogus correspondent node registration. However, in contrast to IPv6 the attacker could only temporarily gain access to the path and continue the attack off-path. For instance, it could intercept the home test and subsequently leave the path between home agent and correspondent node to mount an impersonation attack with address combination no 1. This is called time shifting attack (see e.g. RFC 4225) and is mitigated by a short binding lifetime of 7 minutes, i.e., the attacker must at least move back on-path every 7 minutes to keep the bogus redirection active.

A drawback of the return routability procedure and route optimization mode is that latency and signaling overhead are significantly increased: upon every handover, at least 5 messages (incl. binding update message) must be exchanged and even if the mobile node is not moving, the procedure must be repeated every time the binding lifetime expires (i.e., after 7 minutes). Another drawback is that the procedure is not fully secure: it is based on the assumption that a node that was reachable at the claimed home address and care-of address within the last 7 minutes is not an attacker. A further drawback of the return routability procedure is that it depends on the home agent, which means that route optimized communication is not possible if the home agent is down, although the home agent would not be on the data path for route optimized traffic.

J. Arkko, C. Vogt, W. Haddad, “Applying Cryptographically Generated Addresses (CGA) and Credit-based Authorization (CBU) to Mobile IPv6”, draft-arkko-mipshop-cga-cba-04.txt, June 2006 (available at http://www.ietf.org and incorporated herein by reference) proposes two optimizations for route optimization mode. The first allows the mobile node to send an early binding update with a new, yet-unverified care-of address to improve handover delay, i.e., the care-of address test is done after the binding update has been sent and in parallel to sending data to the new care-of address. However, the correspondent node maintains a credit counter and is only allowed to send as many packets to this yet-unverified care-of address as it has sent to the previous care-of address. This “credit-based authorization” prevents amplification in redirection-based flooding attacks. The second optimization allows mobile node and correspondent node to skip almost all home address tests except of the initial home address test. This reduces signalling overhead and handover delay, but requires that the home address is a Cryptographically Generated Address (CGA) as for example proposed in T. Aura, “Cryptographically Generated Addresses (CGA)”, RFC 3972, March 2005 (available at http://www.ietf.org and incorporated herein by reference). A cryptographically generated address binds a public key to an IPv6 address (or, more specifically, it's interface identifier), which is a strong cryptographic address ownership proof for messages signed with the corresponding private key and makes impersonation attacks practically impossible. The initial home address test is only necessary to verify the prefix of the home cryptographically generated address and to prevent return-to-home flooding attacks (see J. Arkko, C. Vogt, W. Haddad, “Applying Cryptographically Generated Addresses (CGA) and Credit-based Authorization (CBU) to Mobile IPv6”). Due to these mechanisms, the binding lifetime at the correspondent node is allowed to be much higher than 7 minutes, i.e., the return routability procedure does not need to be repeated every 7 minutes.

However, the proposal has drawbacks: First, cryptographically generated addresses are based on public key cryptography and hence require public/private keys and some amount of computation and memory (for signing and verifying messages, and for generating cryptographically generated addresses), which might not be available at all mobile nodes or correspondent nodes. Furthermore, cryptographically generated addresses are not implemented in a large scale for various reasons.

Drawbacks of the Mobile IPv6 route optimization mode are its limited security compared to bi-directional tunneling mode and the high signaling and handover delay. The latter has negative impacts on delay-sensitive applications. The third aspect of the invention proposes mechanisms that can be used either to increase security of the route optimization mode and its variants, or to reduce signaling overhead and handover delay while keeping more or less the same security properties.

Another drawback is the dependency on the home agent and the inability to keep data session active when the home agent is down. The third aspect of the invention can reduce the dependency on the home agent and hence increase the tolerance against home agent crashes.

### SUMMARY OF THE INVENTION

A first object of the invention is to provide an improved method for detecting an attempt from a compromised network element to redirect traffic destined to a mobile node that does not impact handover delay.

A second object of the invention is to provide a method to resolve a race condition at a mobility anchor point in mixed network-based and host-based mobility management and to ensure that a mobility anchor point, upon receiving two binding updates, always accepts the most recent binding update.

A third object of the invention is to enable a mobile node and/or correspondent node to detect spoofed binding cache entries at the correspondent node and to propose a mechanism that allows an authorized registration of a care-of address at a correspondent node even in cases where a mobile node's home agent is not reachable.

Further, another object is to achieve at least one of these objects without requiring the use of cryptographically generated addresses.

An embodiment according to a first aspect of the invention consists in verifying whether, a mobile node is really attached to a Mobile Access Gateway that has sent a PBU message to a Local Mobility Anchor by sending an acknowledgement message not only to the IP address comprised in the just received valid PBU message, but also to the IP address comprised in the previously received valid PBU message. Such mechanism allows the detection of an attack without the need to query the policy store or AAA server at every handover time, thereby preventing an increase of the handover delay.

According to an embodiment according to a first aspect of the invention, the handover delay can be further reduced if the Local Mobility Anchor updates the binding cache entry immediately after receiving a valid PBU from a trusted Mobile Access Gateway and starts the procedure for verifying whether the mobile node is really located at the Mobile Access Gateway that sends the PBU after that, i.e., data traffic can flow immediately to the new location and the attack detection is done concurrently. This optimistic approach ensures that handover delay is not increased compared to regular PMIP handover, while still being able to detect a redirection attack.

One embodiment according to a first aspect of the invention provides a method for verifying an attachment of a mobile node to a network element in a network, said network using a network-based mobility management scheme for managing the mobility of the mobile node, said method comprising receiving a first message on a position of the mobile node in a first network, said first message comprising a first IP address, receiving a second message on a position of the mobile node in a second network, said second message comprising a second IP address, wherein said second network uses a network-based mobility management scheme for managing the mobility of the mobile node, transmitting an acknowledgment message to both the first and second IP address, comparing the first message on the position of the mobile node in the first network and the acknowledgment message, and detecting whether the second message on a position of the mobile node in the second network is falsified based on the comparison result.

Another embodiment according to a first aspect of the invention provides a method for verifying an attachment of a mobile node to a network element in a network, said network using a network-based mobility management scheme for managing the mobility of the mobile node, said method comprising the steps executed by a local mobility anchor of receiving a first message on a position of the mobile node in a first network, said first message comprising a first IP address, receiving a second message on a position of the mobile node in a second network, said second message comprising a second IP address, wherein said second network uses a network-based mobility management scheme for managing the mobility of the mobile node, transmitting an acknowledgment message to both the first and second IP address, said acknowledgment message requesting a re-transmission of a first message on a position of the mobile node in the first network and a second message on a position of the mobile node in the second network, respectively, detecting whether the second message on a position of the mobile node in the second network is falsified based on a re-transmitted message on the position of the mobile node that is received by the local mobility anchor.

Another embodiment according to a first aspect of the invention provides a local mobility anchor adapted to verify an attachment of a mobile node to a network element in a network, said network using a network-based mobility management scheme for managing the mobility of the mobile node, said local mobility anchor comprising receiving means for receiving a first message on a position of a mobile node in a first network, said first message comprising a first IP address, and a second message on a position of the mobile node in a second network, said second message comprising a second IP address, wherein said second network uses a network-based mobility management scheme for managing the mobility of the mobile node, and transmitting means for transmitting an acknowledgment message to both the first and second IP address.

Yet another embodiment according to a first aspect of the invention provides a mobile node, comprising transmitting means for transmitting a first message on a position of the mobile node in a first network, said first network using a mobile node-based mobility management scheme for managing the mobility of the mobile node, receiving means for receiving an acknowledgment message from a local mobility anchor, comparing means for comparing the first message on the position of the mobile node in the first network and the received acknowledgment message, and detecting means for detecting whether a second message received at the local mobility anchor on a position of the mobile node in a second network, said second network using a network-based mobility management scheme for managing the mobility of the mobile node, is falsified based on the comparison result.

Another embodiment according to a first aspect of the invention provides a network element, comprising transmitting means for transmitting a first message on a position of a mobile node in a first network, said first network using a network-based mobility management scheme for managing the mobility of the mobile node, receiving means for receiving an acknowledgment message from a local mobility anchor, comparing means for comparing the first message on the position of the mobile node in the first network and the received acknowledgment message, and detecting means for detecting whether a second message received at the local mobility anchor on a position of the mobile node in a second network, said second network using a network-based mobility management scheme for managing the mobility of the mobile node, is falsified based on the comparison result.

Yet another embodiment according to a first aspect of the invention provides a local mobility anchor adapted to verify an attachment of a mobile node to a network element in a network, said network using a network-based mobility management scheme for managing the mobility of the mobile node, said local mobility anchor comprising receiving means for receiving a first message on a position of a mobile node in a first network, said first message comprising a first IP address, and a second message on a position of the mobile node in a second network, said second message comprising a second IP address, wherein said second network uses a network-based mobility management scheme for managing the mobility of the mobile node, and transmitting means for transmitting an acknowledgment message to both the first and second IP address, said acknowledgment message requesting a re-transmission of a first message on a position of the mobile node in the first network and a second message on a position of the mobile node in the second network, respectively, detecting means for detecting whether the second message on a position of the mobile node in the second network is falsified based on a re-transmitted message on the position of the mobile node that is received by the local mobility anchor.

An embodiment according to a second aspect of the invention consists in introducing an algorithm in the home agent for detection and resolution of race condition of binding updates sent by network-based and client-based mobility mechanism in case that CMIP-HA and PMIP-HA are co-located in a single HA. The HA first needs to detect the change of mobility mechanism for a given MN. This detection of the change of mobility mechanism (i.e. CMIP to PMIP or PMIP to CMIP) is based on the consecutive reception of binding updates of different types, i.e. if the HA receives CBU after PBU or PBU after CBU. This is a first sign that a binding update race condition may occur.

Further, the HA may implement additional mechanisms to refine the detection of BU race condition. According to an embodiment according to a second aspect of the invention, the HA may measure the time difference between the respective arrival times of the binding updates of different types. If this time is shorter than a given time limit, i.e. the binding updates arrive suspiciously close after each other, the HA may conclude that a race condition between binding updates occurred. If the HA doubts about a race condition, the HA rejects the last BU and, as a result, it sends a BU resolution query message, e.g. a binding acknowledgement with Refresh Advise option set to 0, which is denoted BAck[Refr-Adv-Opt=0], to both CoAs, the CoA in the binding cache entry and the CoA in the last BU. Later, the HA receives only one BU resolution reply message (CBU or PBU) from the current MN's location and processes this BU in a usual way.

An embodiment according to a second aspect of the invention provides a method for managing the mobility of a mobile node at a mobile anchor point, said mobile node moving between a first network and a second network, wherein said first network uses a mobile node-based mobility management scheme for managing the mobility of the mobile node, and said second network uses a network-based mobility management scheme for managing the mobility of the mobile node, said mobile anchor point implementing both the mobile node-based mobility management scheme and the network-based mobility management scheme, said method comprising the steps executed by the mobile anchor point of receiving a first message from the mobile node on a first location of the mobile node in the first network, where the mobile node has a first IP address, receiving a second message from a network element in the second network on a second location of the mobile node in the second network, where the mobile node has a second IP address, transmitting a binding request message to at least one of the first and second IP address of the mobile node, receiving a response message for the at least one of the first and second IP address, and determining which one of the first and second IP address is a current IP address of the mobile node based on the received response message.

Another embodiment according to a second aspect of the invention provides a method for managing the mobility of a mobile node at a mobile anchor point, said mobile node moving between a first network and a second network, wherein said first and second network use a network-based mobility management scheme for managing the mobility of the mobile node, said mobile anchor point implementing the network-based mobility management scheme, said method comprising the steps executed by the mobile anchor point of receiving a first message from a first network element in the first network on a first location of the mobile node in the first network, where the mobile node has a first IP address, receiving a second message from a second network element in the second network on a second location of the mobile node in the second network, where the mobile node has a second IP address, transmitting a binding request message to at least one of the first and second IP address the mobile node, receiving a response message for the at least one of the first and second IP address, and determining which one of the first and second IP address is a current IP address of the mobile node based on the received response message.

Another embodiment according to a second aspect of the invention provides a mobile anchor point for managing the mobility of a mobile node, said mobile node moving between a first network and a second network, wherein said first network uses a mobile node-based mobility management scheme for managing the mobility of the mobile node, and said second network uses a network-based mobility management scheme for managing the mobility of the mobile node, said mobile anchor point implementing both the mobile node-based mobility management scheme and the network-based mobility management scheme, and said mobile anchor point comprising receiving means for receiving a first message from the mobile node on a first location of the mobile node in the first network, where the mobile node has a first IP address, and a second message from a network element in the second network on a second location of the mobile node in the second network, where the mobile node has a second IP address, and transmitting means for transmitting a binding request message to at least one of the first and second IP address of the mobile node, wherein said receiving means are adapted to receive a response message for the at least one of the first and second IP address, and said mobile anchor point further comprises determining means for determining which one of the first and second IP address is a current IP address of the mobile node based on the received response message.

Yet another embodiment according to a second aspect of the invention provides a mobile anchor point for managing the mobility of a mobile node, said mobile node moving between a first network and a second network, wherein said first and second network use a network-based mobility management scheme for managing the mobility of the mobile node, said mobile anchor point implementing the network-based mobility management scheme, and said mobile anchor point comprising receiving means for receiving a first message from a first network element in the first network on a first location of the mobile node in the first network, where the mobile node has a first IP address, and a second message from a second network element in the second network on a second location of the mobile node in the second network, where the mobile node has a second IP address, and transmitting means for transmitting a binding request message to at least one of the first and second IP address of the mobile node, wherein said receiving means are adapted to receive a response message for the at least one of the first and second IP address, and said mobile anchor point further comprises determining means for determining which one of the first and second IP address is a current IP address of the mobile node based on the received response message.

Another embodiment according to a second aspect of the invention provides a mobile node moving between a first network and a second network, wherein said first network uses a mobile node-based mobility management scheme for managing the mobility of the mobile node, and said second network uses a network-based mobility management scheme for managing the mobility of the mobile node, said mobile node comprising transmitting means for transmitting to a mobile anchor point for the mobile node a message on a location of the mobile node in the first network, where the mobile node has a first IP address, and receiving means for receiving from the mobile anchor point a binding request message for the first IP address of the mobile node, wherein said transmitting means are adapted to transmit to the mobile anchor point a response message to the received binding request message.

Another embodiment according to a second aspect of the invention provides a network element in a network using a network-based mobility management scheme for managing the mobility of a mobile node, said network element comprising transmitting means for transmitting to a mobile anchor point for the mobile node a message on a location of the mobile node in the network, where the mobile node has an IP address, and receiving means for receiving from the mobile anchor point a binding request message for the IP address of the mobile node, wherein said transmitting means are adapted to transmit to the mobile anchor point a response message to the received binding request message.

One of the goals of a third aspect of the invention is to suggest mechanisms that allow for the detection of a spoofed binding cache entry for a mobile node at a correspondent node. As will be outlined below one solution may be to send a binding acknowledgement for a binding update to the mobile nodes home address and/or its previously registered care-of address. Further, the correspondent node may optionally send a further binding acknowledgement to the new registered care-of address. In the latter example, if the correspondent node does not only send the binding acknowledgment to the new (potentially spoofed) care-of address but also to the previously registered care-of address of the mobile node and/or its home address, the mobile terminal may detect an attack on its binding, for example by recognizing that a binding acknowledgement is received for a binding update that has not been sent by the mobile terminal.

Another option to detect a spoofed binding cache entry of a mobile node may be a binding test in which the correspondent node sends one or more requested/solicited or unsolicited probe messages to the mobile node. These probe messages may allow the mobile node to check/detect whether its binding cache entry at the correspondent node is (still) correct.

Another goal of a third aspect of the invention is to suggest an authorized care-of address registration mechanism which may reduce the signaling overhead and/or which may also allow for the authorized registration of a care-of address at a correspondent node, even in cases where the mobile node's home agent is down. The proposed mechanism according to the third aspect of the invention may be advantageous in that it does not require cryptographically generated address to be used by mobile node and correspondent node. According to this aspect, a so-called permanent token (or permanent keygen token) is used for the authentication of binding updates. Different embodiments also discuss how such permanent token may be generated at mobile node and correspondent node and when and how to update the permanent token, for example in response to the detection of an attack on the mobile node's binding at the correspondent node.

According to one embodiment according to a third aspect of the invention, a method for detecting whether a binding cache entry for a mobile at a correspondent node has been spoofed is provided. In this embodiment, it is assumed that the mobile node has at least one home address in its home network and at least one care-of address in a foreign network. In this embodiment the correspondent node transmits at least one binding acknowledgement to the mobile node in response to receiving an authorized binding update. One binding acknowledgement is thereby destined to the mobile node's home address in its home network. Alternatively (or in addition to sending the binding update to the mobile node's home address) the correspondent node may also destine one binding acknowledgment to the care-of address that has been deregistered by the authorized binding update. The mobile node receives at the least one binding acknowledgment and may detect whether a binding cache entry at the correspondent node for the mobile has been spoofed based on the at least one received binding acknowledgment.

According to another embodiment according to a third aspect of the invention, the correspondent node may destine a further binding acknowledgment to the new care-of address provided in the authorized binding update.

In one embodiment according to a third aspect of the invention, it is determined whether the binding cache entry for the mobile node at the correspondent node is spoofed by determining at the mobile node, whether the at least one binding acknowledgment is received for an authorized binding update that has been transmitted by the mobile node.

In another embodiment according to a third aspect of the invention, it is determined whether the binding cache entry for the mobile node at the correspondent node is spoofed by determining at the mobile node, whether a sequence number in the at least one received binding acknowledgment matches a sequence number of an unacknowledged authorized binding update.

In another embodiment according to a third aspect of the invention, it is further detected at the mobile node that the home agent at which the mobile node is registered is down. If so, the mobile node may inform the correspondent node on the home agent being down.

Another embodiment according to a third aspect of the invention relates to a method for detecting whether a binding cache entry for a mobile at a correspondent node has been spoofed. In this embodiment, the mobile node has at least one care-of address in a foreign network. The mobile node and the correspondent node perform a binding test. This binding test may include the transmission of binding test messages from the transmitting the correspondent node to the mobile node using the mobile node's care-of address. A spoofed binding cache entry at the correspondent node may be detected based on the binding test.

In a variation of this embodiment, the mobile node may detect that a binding cache entry for the mobile node at the correspondent node has been spoofed, if the mobile node does not receive a binding test message from the correspondent node for a threshold time period.

In another variation of the embodiment, the binding test messages may be unsolicited messages sent by the correspondent node. Further, it may also be foreseen that the binding test messages are transmitted periodically.

In a further embodiment according to a third aspect of the invention the binding test messages are transmitted by the correspondent node in case the correspondent node has—e.g. temporarily—no data packets to transmit to the mobile node.

In another embodiment according to a third aspect of the invention, the binding test further comprises sending at least one binding test request message from the mobile node to the correspondent node for requesting the correspondent node to transmit the binding test messages. In a variation of this embodiment, spoofed binding cache entry at the correspondent node may be detected by the mobile node, if no response to one or more probe messages is received by the mobile node from the correspondent node. In another variation of this embodiment, the binding test utilizes messages of the ICMP protocol, such as for example an ICMP echo request and/or an ICMP echo response message.

In another embodiment according to a third aspect of the invention, the binding test message(s) is a binding acknowledgment message(s).

Another embodiment according to a third aspect of the invention relates to performing counter measures to a detected attack on the mobile terminal's binding. For example, the mobile node may perform at least one of the following counter measures in response to detecting a spoofed binding cache entry at the correspondent node.

One possible counter measure is to perform a return routability procedure with the correspondent node. This procedure may provide the mobile node with cryptographic information. Subsequent to the return routability procedure the mobile terminal may then transmit an authorized binding update to the correspondent node to correct the spoofed binding cache entry. Thereby, the authorized binding update is authenticated by using the cryptographic information obtained by performing the return routability procedure. Optionally, a permanent keygen token may be determined by mobile node and correspondent node as part of the return routability procedure.

Another possible counter measure may be that the mobile node informs the correspondent node on the spoofed binding cache entry.

A further counter measure is to not/no longer use route optimization in exchanging data between mobile node and correspondent node. According to an exemplary embodiment according to a third, aspect of the invention this may include that all date exchanged between mobile node and correspondent node upon having detected the attack on the mobile node's binding are transmitted through the mobile node's home network. As a consequence, the correspondent would no longer has a binding cache entry for the mobile node which would ultimately prevent potential attacking nodes from spoofing a mobile node's binding cache entry at the correspondent node.

In case the correspondent node is informed on the spoofed binding cache entry, it is suggested that, according to another embodiment according to a third aspect of the invention, the correspondent node blocks further binding updates for registering the care-of address in the spoofed binding cache entry and/or blocks further binding updates for registering a care-of address having a prefix equal or similar to that of the care-of address in the spoofed binding cache entry. This may have the advantage that the attacking node from its current position may be prevented to launch further attacks on the binding cache entries at the correspondent node.

In another embodiment according to a third aspect of the invention, the home agent of the mobile node may authenticate a message that is transmitted from the mobile node via the home agent to the correspondent node for informing the correspondent node on the spoofed binding cache entry.

In a further embodiment according to a third aspect of the invention the mobile node determines a message authentication code based on at least a permanent keygen token known to the mobile node and the correspondent node. Further, the mobile node may include this message authentication code to an authorized binding update that is to be transmitted to the correspondent node. This authorized binding update may further comprise a flag that, when set, indicates to the correspondent node to validate the message authentication code based on the permanent keygen token. The use of a permanent keygen token may for example allow for skipping a home-address test in a return routability procedure, which may be inter alia advantageous if the home agent serving the mobile node in its home network associated to the mobile node's home address is not responding or is down.

The generation of message authentication code may for example be implemented as follows. The correspondent node may send a message comprising a care-of keygen token to the mobile node. This message may be destined to the mobile node's care-of address currently registered with the correspondent node. Having received this message, the mobile node may determine the message authentication code based on at least the permanent keygen token and using the care-of keygen token.

In another embodiment according to a third aspect of the invention, the mobile node sends an authorized binding update to the correspondent node for registering a care-of address for the mobile node at the correspondent node. This authorized binding update may comprise a message authentication code and a flag that, when set, indicates to the correspondent node to determine a permanent keygen token.

Generally, the permanent keygen token may be of finite or in some cases also of infinite validity.

According to one embodiment according to a third aspect of the invention, the permanent keygen token determined by the correspondent node is identical to a permanent keygen token determined by the mobile node.

Another embodiment according to a third aspect of the invention relates to the determination of the permanent keygen token. Its determination may for example be based on at least one of a home keygen token being a keygen token provided to the mobile node in a message from the correspondent node destined to the mobile node's home address, and/or a care-of keygen token being a keygen token provided to the mobile node in a message from the correspondent node destined to the mobile node's care-of address.

In one exemplary embodiment according to a third aspect of the invention, the determination of the permanent keygen token is based on at least one keygen token provided by the correspondent node in a home address test and/or care-of address test of a return routability procedure.

As previously mentioned, the mobile terminal may generate a message authentication code. According to one exemplary embodiment according to a third aspect of the invention, the mobile node, determines the message authentication code based on at least one of a home keygen token being a keygen token provided to the mobile node in a message from the correspondent node destined to the mobile node's home address, and a care-of keygen token being a keygen token provided to the mobile node in a message from the correspondent node destined to the mobile node's care-of address.

As should have become apparent, it is thus foreseen in different embodiments according to a third aspect of the invention that a permanent keygen token is determined by the mobile node and/or the correspondent node.

In one further exemplary embodiment according to a third aspect of the invention, the mobile node may determine the permanent keygen token in response to receiving at least one binding acknowledgment for an authorized binding update from the mobile node.

In another exemplary embodiment according to a third aspect of the invention, the permanent keygen token is determined at the correspondent node in response to receiving an authorized binding update from the mobile node. The authorized binding update in response to which the permanent keygen token is determined according to this embodiment may for example comprise a flag that, when set, indicates to the correspondent node to determine a permanent keygen token.

Another embodiment according to a third aspect of the invention relates to a method for registering a care-of address of a mobile node at a correspondent node. According to this method the mobile node and the correspondent node may perform a care-of address test thereby providing a care-of keygen token to the mobile node. Further, the mobile node may transmit an authorized binding update from to the correspondent node, wherein the authorized binding update comprises a message authentication code determined by the mobile terminal based on the care-of keygen token and a permanent keygen token known to the mobile node and the correspondent node.

For example, the permanent keygen token could be (or could be generated based on) a home keygen token provided to the mobile terminal in the last successful home address test prior to the home agent going down.

In a further embodiment according to a third aspect of the invention, the correspondent node transmits at least one binding acknowledgement for the authorized binding update to the mobile node. The correspondent node may destine this at least one binding acknowledgment may be destined to the care-of address deregistered by the authorized binding update.

In a variation, the correspondent node may destine the at least one binding acknowledgment to the care-of address deregistered by the authorized binding update (only) in cases where the correspondent node detects or is informed by the mobile node that the home agent is down.

In another embodiment according to a third aspect of the invention, several mechanisms for detecting an unreachable home agent are suggested. The home agent may be considered or detected being down (or unreachable) by either one or a combination of the following mechanisms. One option would be to detect at the mobile node that no binding acknowledgement is received at the mobile node for an authorized binding update transmitted by the mobile node to the home agent. Another option is the use of the IPsec Dead Peer Detection procedure for this purpose. A further option suggested herein is to detect by the mobile node or the correspondent node that no response to one or more probe messages sent to the home agent or to a home address of the mobile terminal registered at this home agent is received.

In another embodiment according to a third aspect of the invention, the correspondent node may be informed by the mobile node that the home agent where the mobile node is registered is down by sending a notification message from the mobile node to the correspondent node.

It may be advantageous that the notification message is authenticated by the mobile node. For authentication of the notification a binding management key that has been previously determined in a return routability procedure including a home address test and a care-of address test could be used.

Moreover, another option may be that the notification is sent as part of an authorized binding update transmitted by the mobile node to the correspondent node.

Furthermore, in another embodiment according to a third aspect of the invention the method for registering a care-of address of a mobile node at a correspondent node according to the different embodiments according to a third aspect of the invention described above may further include the steps of the method for detecting whether a binding cache entry for a mobile at a correspondent node has been spoofed according to the different embodiments according to a third aspect of the invention described herein.

Another embodiment according to a third aspect of the invention relates to a mobile node for detecting whether a binding cache entry for the mobile node at a correspondent node has been spoofed. The mobile node is assigned at least one home address in its home network and at least one care-of address in a foreign network. According to this exemplary embodiment, the mobile node comprises a receiver for receiving at least one acknowledgement sent by the correspondent node. The correspondent node have destined one binding acknowledgement to the mobile node's home address in its home network, and/or one to the care-of address deregistered by the authorized binding update. Further, the mobile node may have a processing unit for detecting whether a binding cache entry at the correspondent node for the mobile has been spoofed based on the at least one received binding acknowledgment.

In another embodiment according to a third aspect of the invention, a mobile node may comprise means adapted to perform or to participate in the steps of any method for detecting whether a binding cache entry for a mobile at a correspondent node has been spoofed and/or the method for method for registering a care-of address of a mobile node at a correspondent node according to one of the various embodiments described herein.

A further embodiment according to a third aspect of the invention relates to a correspondent node for maintaining a binding cache entry for a mobile node. As in other embodiment, it may be assumed that the mobile node is assigned at least one home address in its home network and at least one care-of address in a foreign network. The correspondent node may comprise a communication unit (e.g. including a transmitter) for transmitting in response to receiving an authorized binding update, at least one binding acknowledgement to the mobile node. Thereby the correspondent node destines one binding acknowledgement to the mobile node's home address in its home network and/or the care-of address deregistered from the correspondent node's binding cache by the authorized binding update.

In another embodiment according to a third aspect of the invention, the correspondent node comprises means adapted to perform or to participate in the steps of the method for detecting whether a binding cache entry for a mobile at a correspondent node has been spoofed and/or the method for method for registering a care-of address of a mobile node at a correspondent node according to one of the various embodiments described herein.

A further embodiment according to a third aspect of the invention relates to another mobile node for detecting whether a binding cache entry for the mobile node at a correspondent node has been spoofed. Here, the mobile node may be assigned at least one care-of address in a foreign network. The mobile node according to this embodiment may comprise a communication means for performing a binding test including receiving from the correspondent node binding test messages destined to the mobile node's care-of address. Further, the terminal may include a processing unit for detecting a spoofed binding cache entry at the correspondent node based on the binding test.

Another embodiment according to a third aspect of the invention provides a further correspondent node for maintaining a binding cache entry for a mobile node. Also here the mobile node may be assigned at least one care-of address in a foreign network. The correspondent node according to this exemplary embodiment may include a receiver for receiving at least one binding test request message from the mobile node as part of a binding test and a transmitter for transmitting binding test messages destined to the mobile node's care-of address in response to the at least one binding test request message as part of the binding test.

An even further embodiment according to a third aspect of the invention relates to a mobile node for registering a care-of address at a correspondent node comprising a communication unit for performing by the mobile node and the correspondent node a care-of address test thereby providing a care-of keygen token to the mobile node. Moreover, this communication unit might be operable to transmit an authorized binding update from the mobile node to the mobile node. This authorized binding update could comprise a message authentication code determined by the mobile terminal based on the care-of keygen token and a permanent keygen token known to the mobile node and the correspondent node.

Another correspondent node according to a further embodiment according to a third aspect of the invention may be used in registering a care-of address for a mobile node. This correspondent node could comprise a communication unit for performing by the mobile node and the correspondent node a care-of address test thereby providing a care-of keygen token to the mobile node. The communication unit may for example be operable to receive an authorized binding update from the mobile node to the mobile node, wherein the authorized binding update comprises a message authentication code determined by the mobile terminal based on the care-of keygen token and a permanent keygen token known to the mobile node and the correspondent node.

Moreover, another embodiment according to a third aspect of the invention relates to a mobile communication system comprising a mobile node and/or a correspondent node according one of the various embodiments of the invention described herein.

Another embodiment according to a third aspect of the invention provides a computer readable medium storing instructions that, when executed by a processor of a mobile node, cause the mobile node to detect whether a binding cache entry for the mobile node at a correspondent node has been spoofed. According to one exemplary embodiment, the mobile node is assigned at least one home address in its home network and at least one care-of address in a foreign network. The instructions stored on the computer-readable medium according to this embodiment of the invention—when executed by the processing unit of the mobile node—cause the mobile node to receive at least one of at least one binding acknowledgement sent by the correspondent node. One binding acknowledgement has been destined to the mobile node's home address in its home network and/ore one binding acknowledgement has been destined to the care-of address deregistered by the authorized binding update. Further, the instructions may cause the mobile node detecting whether a binding cache entry at the correspondent node for the mobile has been spoofed based on the at least one received binding update.

Another embodiment according to a third aspect of the invention provides a computer readable medium storing instructions that, when executed by a processor of a correspondent node, cause the correspondent node to maintain a binding cache entry for a mobile node, wherein the mobile node is assigned at least one home address in its home network and at least one care-of address in a foreign network. This may be achieved by causing the corresponding node to transmit in response to receiving an authorized binding update, at least one binding acknowledgement to the mobile node, wherein one binding acknowledgement is destined to the mobile node's home address in its home network and/or one binding acknowledgement is destined to the mobile node's care-of address that is deregistered by the authorized binding update.

A further computer readable medium according to another embodiment according to a third aspect of the invention stores instructions that, when executed by a processor of a mobile node, cause the mobile node to detect whether a binding cache entry for the mobile node at a correspondent node has been spoofed, wherein the mobile node is assigned at least one care-of address in a foreign network, by performing a binding test including receiving from the correspondent node binding test messages destined to the mobile node's care-of address, and detecting a spoofed binding cache entry at the correspondent node based on the binding test.

Another computer readable medium according to another embodiment according to a third aspect of the invention stores instructions that, when executed by a processor of a correspondent node, cause the correspondent node to maintain a binding cache entry for a mobile node, wherein the mobile node is assigned at least one care-of address in a foreign network, by receiving at least one binding test request message from the mobile node as part of a binding test and transmitting binding test messages destined to the mobile node's care-of address in response to the at least one binding test request message as part of the binding test.

A further embodiment according to a third aspect of the invention provides a computer readable medium storing instructions that, when executed by a processor of a mobile node, cause the mobile node to register a care-of address at a correspondent node, by performing by the mobile node and the correspondent node a care-of address test thereby providing a care-of keygen token to the mobile node, and transmitting an authorized binding update from the mobile node to the mobile node, wherein the authorized binding update comprises a message authentication code determined by the mobile terminal based on the care-of keygen token and a permanent keygen token known to the mobile node and the correspondent node.

An even further embodiment according to a third aspect of the invention relates to a computer readable medium storing instructions that, when executed by a processor of a correspondent node, cause the correspondent node to register a care-of address for a mobile node, by performing by the mobile node and the correspondent node a care-of address test thereby providing a care-of keygen token to the mobile node, and receiving an authorized binding update from the mobile node to the mobile node, wherein the authorized binding update comprises a message authentication code determined by the mobile terminal based on the care-of keygen token and a permanent keygen token known to the mobile node and the correspondent node.

Another embodiment of the invention according to a third aspect of the invention provides a computer readable medium storing instructions that, when executed by the processor of a mobile node or correspondent node, cause the mobile node or correspondent node, respectively, to perform or to participate in the steps of the method for detecting whether a binding cache entry for a mobile at a correspondent node has been spoofed and/or the method for method for registering a care-of address of a mobile node at a correspondent node according to one of the various embodiments described herein.

### BRIEF DESCRIPTION OF THE FIGURES

In the following, the invention is described in more detail in reference to the attached figures and drawings. Similar or corresponding details in the figures are marked with the same reference numerals.

FIG. 1 shows an example of a compromised Mobile Access Gateway redirecting traffic destined to a mobile node that is not attached thereto;

FIG. 2 shows an example of a signaling flow according to a first embodiment of the invention according to a first aspect, wherein a compromised Mobile Access Gateway in a PMIP domain attempts to redirect traffic destined to a mobile node located outside the PMIP domain;

FIG. 3 shows an example of a signaling flow according to the first embodiment of the invention according to a first aspect, wherein a compromised Mobile Access Gateway in a PMIP domain attempts to redirect traffic destined to a mobile node located inside the PMIP domain;

FIG. 4 shows an example of a signaling flow according to a second embodiment of the invention according to a first aspect, wherein a compromised Mobile Access Gateway in a PMIP domain attempts to redirect traffic destined to a mobile node located outside the PMIP domain;

FIG. 5 shows an example of a signaling flow according to the second embodiment of the invention according to a first aspect, wherein a compromised Mobile Access Gateway in a PMIP domain attempts to redirect traffic destined to a mobile node located inside the PMIP domain.

FIG. 6 shows an exemplary signaling flow for PMIPv6 during initial attachment;

FIG. 7 shows an exemplary signaling flow for PMIPv6 during handover from a CMIP-based network domain into a PMIP-based network domain (CMIP to PMIP mobility transition);

FIG. 8 shows a co-located PMIP/CMIP-HA scenario;

FIG. 9 shows an example of BU race condition in a CMIP to PMIP mobility transition;

FIG. 10 shows an example of BU race condition in a PMIP to CMIP mobility transition;

FIG. 11 shows a solution of the BU race condition scenario in a CMIP to PMIP mobility transition according to a second aspect of the invention;

FIG. 12 shows a solution of the BU race condition scenario in a PMIP to CMIP transition according to a second aspect of the invention;

FIG. 13 shows an example of detection of BU race condition according to a second aspect of the invention, although the arrival of BU′s is correct (in order);

FIG. 14 shows an exemplary flow chart in the PMA showing the processes (also the optional ones) needed to support the resolution of freshest BU procedure according to a second aspect of the invention;

FIG. 15 exemplifies the use of bi-directional tunneling for a communication between a mobile node and a correspondent node according to MIPv6;

FIG. 16 exemplifies the use of route optimization for a communication between a mobile node and a correspondent node according to MIPv6;

FIG. 17 shows the actions performed by a mobile node upon obtaining a new care-of address in a foreign network according to MIPv6;

FIG. 18 shows a return routability procedure and a care-of address registration performed by a mobile node and a correspondent according to MIPv6;

FIG. 19 shows an exemplary sequence of messages exchanged between an attacker, a mobile node, a correspondent node and a home agent allowing the mobile node to detect an attack on its binding at the correspondent node based on binding acknowledgement sent via the mobile node's home network according to an exemplary embodiment according to a third aspect of the invention;

FIG. 20 shows an exemplary sequence of messages exchanged between an attacker, a mobile node, a correspondent node and a home agent allowing the mobile node to detect an attack on its binding at the correspondent node based on a binding test according to an exemplary embodiment according to a third aspect of the invention;

FIG. 21 shows an exemplary sequence of messages exchanged between a mobile node, a correspondent node and a home agent according to an improved return routability procedure and subsequent care-of address registration according to an exemplary embodiment according to a third aspect of the invention;

FIG. 22 shows a sequence of steps and messages exchanged between a mobile node and a correspondent node for registering a care-of address of the correspondent node according to an exemplary embodiment according to a third aspect of the invention where a permanent token is used for authentication;

FIG. 23 shows another sequence of steps and messages exchanged between a mobile node, home agent and a correspondent node for registering a care-of address of the correspondent node according to an exemplary embodiment according to a third aspect of the invention where a permanent token is used for authentication; and

FIG. 24 shows a further sequence of steps and messages exchanged between a mobile node, attacker, home agent and a correspondent node according to an exemplary embodiment according to a third aspect of the invention where a permanent token is used for authentication and where a mobile node detects that the attacker has spoofed its binding cache entry the correspondent node.

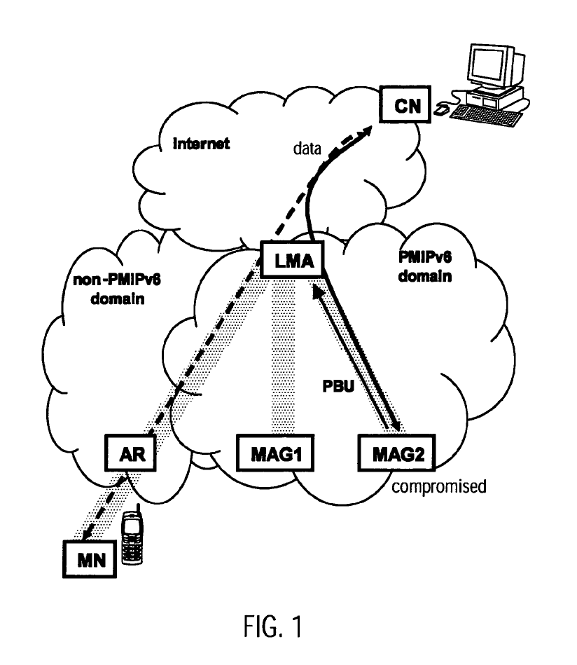

### DETAILED DESCRIPTION OF THE INVENTION

The following paragraphs will describe various aspects of the invention. Further, several embodiments will be described. For exemplary purposes only, most of the embodiments are outlined in relation to an a communication network using MIPv6 as discussed in the Background Art section above, but the invention is not limited to its use in this particular exemplary communication network.

Accordingly, also the terminology used herein mainly bases on the terminology used by the IETF in the standardization of Mobile IPv6. However, the terminology and the description of the embodiments with respect to and Mobile IPv6 is not intended to limit the principles and ideas of the inventions to such systems and the use of this protocol only.

The explanations given in the Technical Background section above are intended to better understand the specific exemplary embodiments described herein and should not be understood as limiting the invention to the described specific implementations of processes and functions in the mobile communication network. Nevertheless, the improvements proposed herein may be readily applied in the protocols/systems described in the Technological Background section and may in some embodiments of the invention also make use of standard and improved procedures of theses protocols/systems.

In the following a definition of several terms frequently used in this document will be provided.

A correspondent node or mobile node is a physical entity within a communication network. One node may have several functional entities. A functional entity refers to a software or hardware module that implements and/or offers a predetermined set of functions to other functional entities of a node or the network. Nodes may have one or more interfaces that attach the node to a communication facility or medium over which nodes can communicate. Similarly, a network entity may have a logical interface attaching the functional entity to a communication facility or medium over it may communicate with other functional entities or nodes.

An address of a node or functional entity is a global or site-local identifier of the node or functional entity being either of permanent or temporarily limited validity. Typically, in some of the embodiments herein an address is a network layer address, i.e. is used for identification of nodes and network entities on the network layer of the OSI reference model (see for example the textbook “Computer Networks”, by Andrew S. Tanenbaum, fourth edition, 2003, Prentice Hall PTR, chapter 1.4 incorporated herein by reference). The network layer or Layer 3 typically provides the functional and procedural means for transferring variable length packets from a source to a destination via one or more networks.

Typically, an interface of a node is assigned one address. However, would also be possible to assign multiple addresses to a single interface. Further, in case of a node comprising plural functional entities, one or more addresses may be associated to a logical interface of a respective functional entity.

Generally, each network is identified by at least one number e.g. a so-called prefix. This number allows for routing of packets to the nodes in the network. Furthermore, this number refers to a pool of identifiers that can be used by the nodes in the network. An address in a network is an identifier out of the pool of identifiers. For example in IPv6, the number of a network is the IPv6 prefix and the address in a network is the IPv6 address composed of the IPv6 prefix and an IPv6 host part. In different networks, for example in a home network and a foreign network different addresses are used.

A home network of a mobile node is typically identified by the location of the home agent at which the mobile node registers its care-of address(es) for a given home address of the mobile node.

A home address is an address assigned to a mobile node, used as the permanent address of the mobile node. This address is defined within the mobile node's home network. A mobile node may have multiple home addresses, for instance when there are multiple home networks or a mobile node may have multiple home addresses in a single home network.

A care-of address is an address associated with a mobile node while visiting a foreign network. A mobile node may have one or more care-of addresses simultaneously.

A binding is an association of the home address of a mobile node with a care-of address for that mobile node. In some embodiments of the invention the remaining lifetime of that association may also be part of the binding. Bindings are generated by way of registration which denotes a process during which a mobile node or a proxy sends a binding update to the mobile node's home agent or a correspondent node, causing a binding for the mobile node to be registered. The bindings may for example be stored in a binding cache of the mobile node's home agent or a correspondent node, respectively. An authorized binding update is a message for registering a binding. The registration of the binding is authorized by authenticating the sender of the authorized binding update, e.g. by means of a message authentication code (MAC) or another authentication mechanism (e.g. signing the binding update by means a public/private key pair).

In some embodiments of the invention the IPv6 protocol is used on the network layer. In this case the address is an identifier for a single (logical) interface of a node such that a packet sent to it from another IPv6 subnet is delivered via a lower-layer link to the (logical) interface identified by that address.

A home agent is a router or a functional entity providing a routing function on a mobile node's home network with which the mobile node registers its current care-of address(es). While the mobile node is away from home, the home agent may intercept packets on the home link destined to the mobile node's home address, encapsulate them, and tunnel them to one of or a some of the mobile node's registered care-of address(es).

If route optimization is used a mobile node and a correspondent node exchange data packets directly without passing same through the mobile node's home network. Instead the correspondent node sends data packets to the mobile node's care-of address registered in the correspondent node's binding cache. Similarly, also the mobile node does not transmit the data packets to the corresponding node through its home network (i.e. via the home agent) but destines the data packets directly to an address of the correspondent node.

In the following, a first aspect of the invention will be described.

This first aspect will be described with respect to a situation where the functionalities of the Local Mobility Anchor and Home Agent are co-located in a same physical entity. The terms “Local Mobility Anchor” and “Home Agent” will hence be used interchangeably. Furthermore, the invention according to this first aspect will be described with respect to a situation where a mobile node is allowed to switch between a network-based mobility management scheme and a host-based mobility management scheme during an application session. An example of a network-based mobility management scheme that can be used is the PMIPv6 protocol as defined in S. Gundavelli, K. Leung, V. Devarapalli, K. Chowdhury, B. Patil, Proxy Mobile IPv6, draft-sgundave-mip6-proxymip6-02, March 2007. However, the invention according to this first aspect is not limited to this protocol and other network-based mobility management schemes such as PMIPv4 or other variants of PMIP can be used.

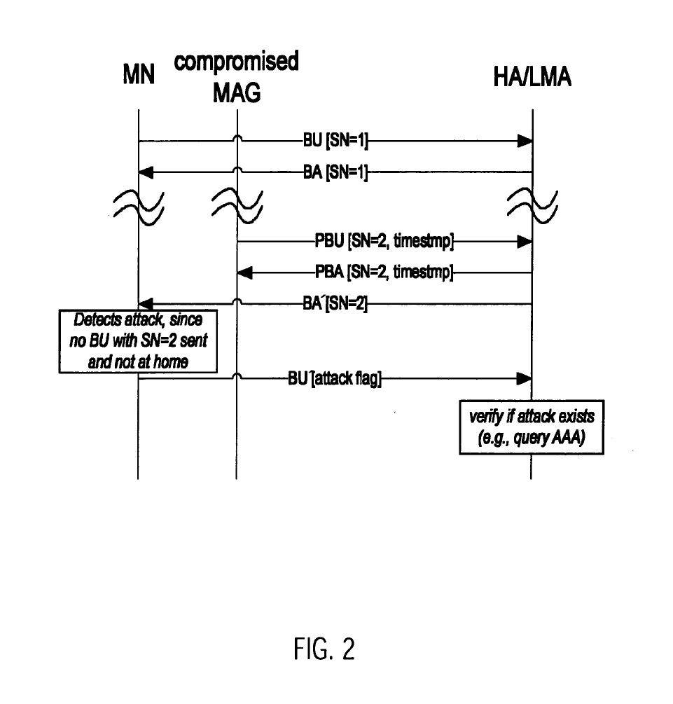

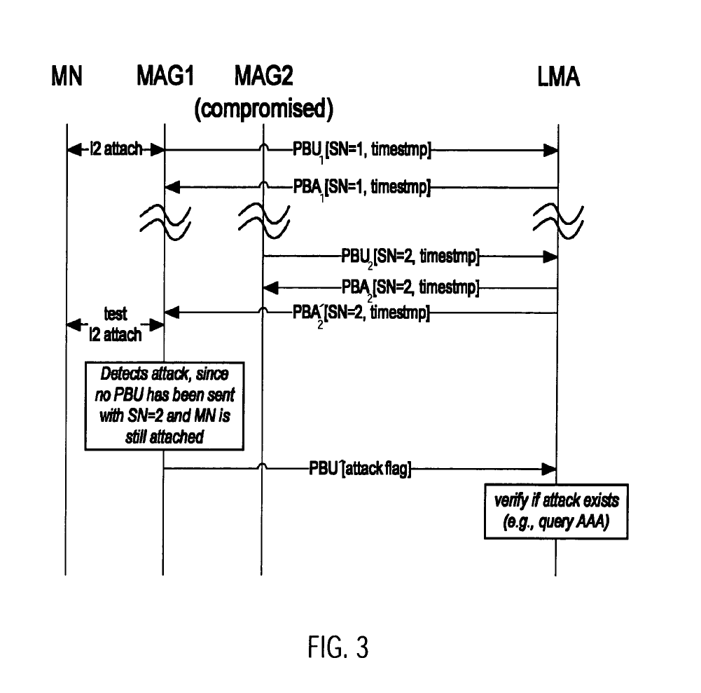

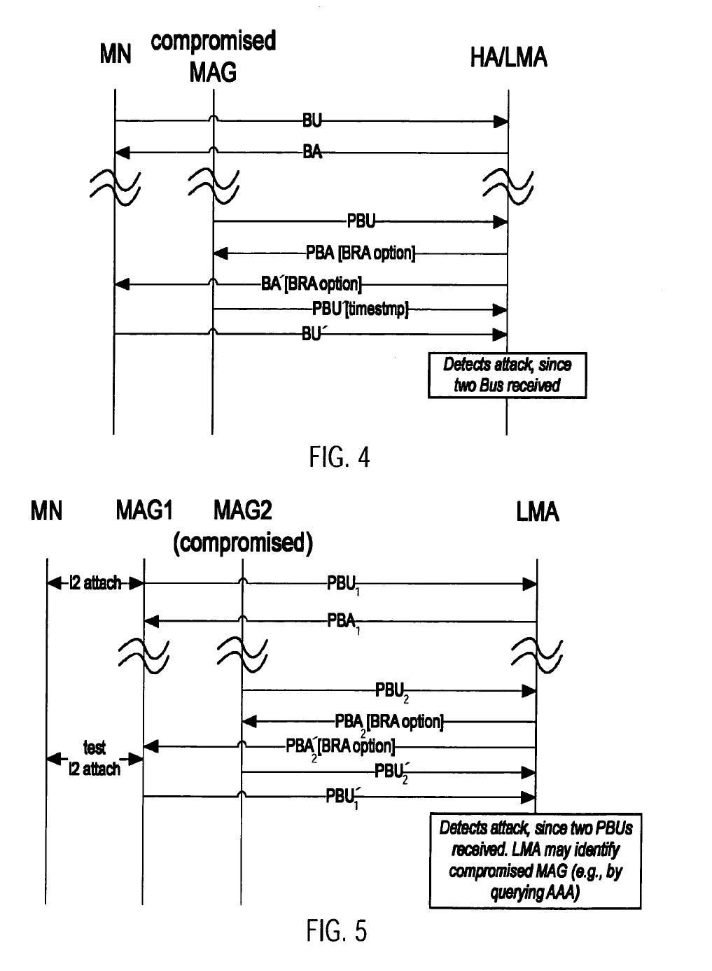

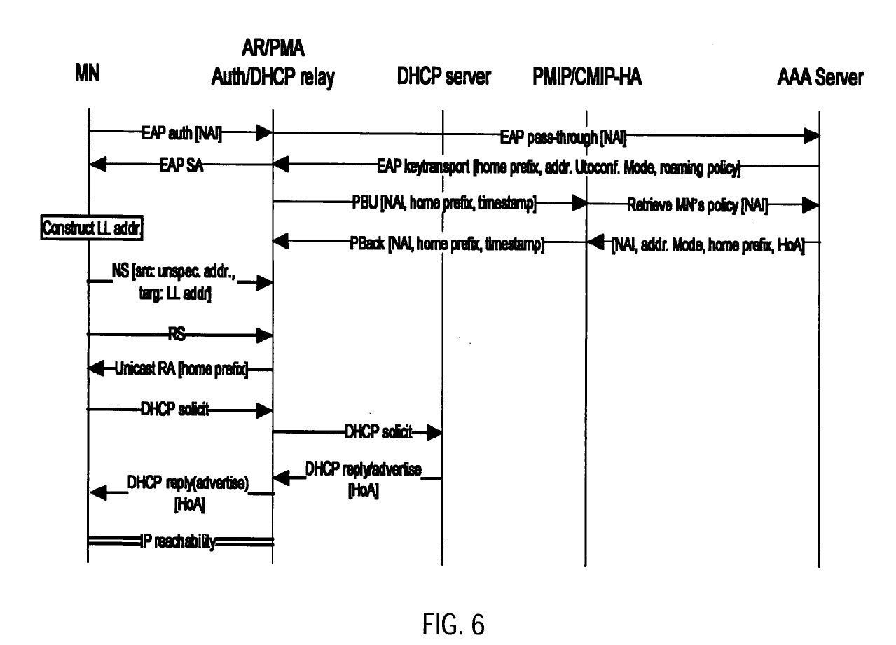

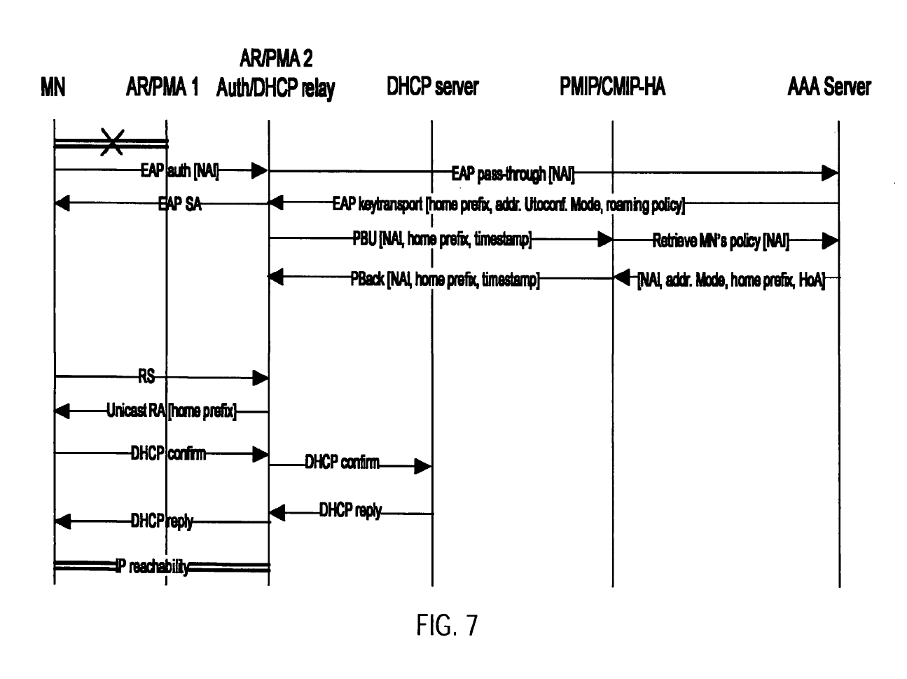

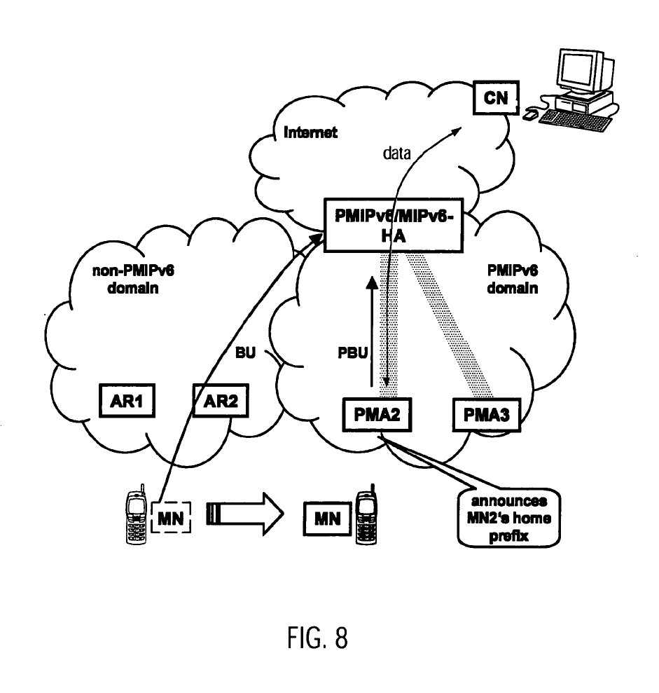

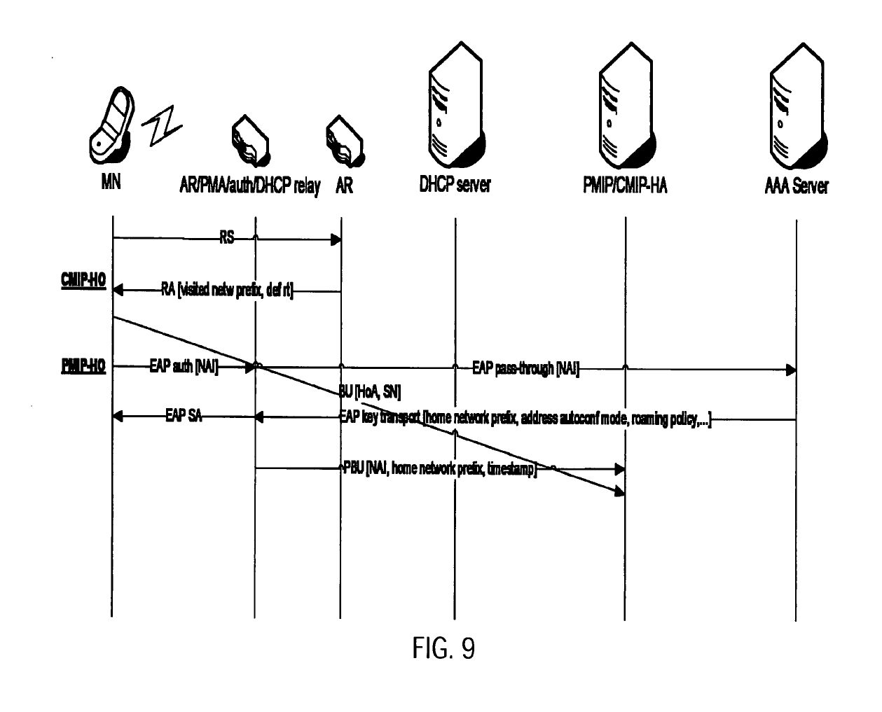

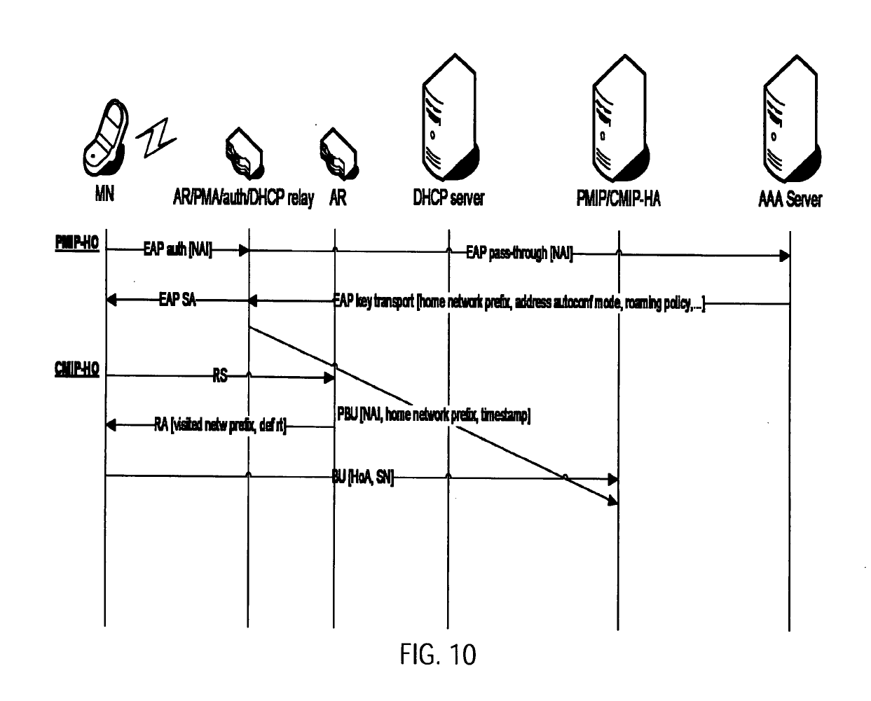

In the following, two embodiments of the invention according to a first aspect will be described. A first embodiment will be described with respect to FIGS. 2 and 3, while a second embodiment will be described with respect to FIGS. 4 and 5.

A first variant of the first embodiment according to a first aspect will be described with respect to FIG. 2. A mobile node is located in a domain implementing a client-based mobility management scheme. The mobile node thus communicates its position by sending a binding update message BU to a Local Mobility Anchor LMA. The Local Mobility Anchor LMA first checks authentication information contained in the binding update message BU to identify that this binding update BU can be trusted. After having accepted the binding update, the Local Mobility Anchor LMA then transmits a binding acknowledgment message BA to the Care-of-Address of the mobile node contained in the binding update BU to confirm that the Care-of-Address was saved in the binding cache entry of the Local Mobility Anchor LMA.

FIG. 2 illustrates an attempt by a compromised Mobile Access Gateway in a domain implementing a network-based mobility management scheme to redirect traffic destined to the mobile node. The Mobile Access Gateway transmits a bogus proxy binding update message PBU to the Local Mobility Anchor LMA. The Local Mobility Anchor updates its binding cache entry correspondingly by replacing the old Care-of-Address of the mobile node by the new Care-of-Address of the Mobile Access Gateway contained in the bogus proxy binding update PBU. The Local Mobility Anchor LMA then sends a proxy binding acknowledgement message PBA to the Care-of-Address of the compromised Mobile Access Gateway. Further, the Local Mobility Anchor LMA transmits a binding acknowledgement BA′ to the Care-of-Address of the mobile node previously saved in the binding cache entry, in addition to the proxy binding acknowledgment message PBA sent to the newly saved Care-of-Address of the compromised Mobile Access Gateway.

The mobile node can detect an attempt to redirect traffic by the compromised Mobile Access Gateway by comparing the received binding acknowledgment message BA′ and the binding update messages that the mobile node previously sent to the Local Mobility Anchor LMA. If the mobile node notices a binding acknowledgment message that does not correspond to any binding update message that it sent to the Local Mobility Anchor LMA, then the mobile node detects a potential attempt of redirecting traffic by a corn promised Mobile Access Gateway.

The mobile node can check whether a binding acknowledgment message corresponds to a binding update message by consulting the binding update list, which contains information about the previously sent binding update messages.

According to an embodiment of the invention according to a first aspect, a binding acknowledgment message is defined as corresponding to a specific binding update message, if the respective sequence numbers of the binding update message and binding acknowledgment message are equal to each other and no binding acknowledgment message has yet been received for this specific binding update so far, i.e. this binding acknowledgment message is the first one received. However, other ways of mapping a binding update message to a binding acknowledgment message may be used.

In the example illustrated in FIG. 2, the mobile node first transmits a binding update message BU to indicate its position to the Local Mobility Anchor LMA. This binding update message BU comprises a sequence number SN equal to 1. The binding acknowledgment message BA sent by the Local Mobility Anchor LMA comprises a sequence number having a value of 1 and thus corresponds to the binding update message BU transmitted by the mobile node.

The compromised Mobile Access Gateway, however, cannot obtain the value of the sequence number in a binding update message from the mobile node. Hence, the proxy binding update message PBU sent by the compromised Mobile Access Gateway to the Local Mobility Anchor LMA has a sequence number value that differs from the sequence number value of the binding update message from the mobile node. In the example in FIG. 2, the proxy binding update message PBU has a sequence number value of 2. The Local Mobility Anchor LMA, as a response to the proxy binding update message PBU, sends a proxy binding acknowledgment PBA to the Care-of-Address of the Mobile Access Gateway that has a sequence number value of 2. Further, the Local Mobility Anchor LMA transmits a further binding acknowledgment message BA′ to the Care-of-Address of the mobile node previously saved in the binding cache entry. This further binding acknowledgment message BA′ has a sequence number of 2.

The mobile node, upon receiving the binding acknowledgment message BA′ from the Local Mobility Anchor LMA, compares the binding acknowledgment message BA′ with the previously sent binding update message BU. The mobile node notices that the sequence numbers of the respective messages do not correspond since the sequence number of the binding update message BU has a value of 1 and that of the binding acknowledgment message BA′ is 2. Hence, the mobile node detects an attack.

Moreover, in case the Mobile Access Gateway was able to retrieve the current value of the sequence number exchanged between the mobile node and the Local Mobility Anchor, the Mobile Access Gateway could transmit a binding acknowledgment message BA′ having a sequence number value that corresponds to that of a binding update message transmitted by the mobile node, i.e. a value of 1. However, the mobile node would notice, by consulting the binding update list, that a binding acknowledgment BA has already been received, which has a sequence number value of 1, thus corresponding to the binding update message BU. Hence, the mobile node would notice that the binding acknowledgment message BA′ is the second binding acknowledgment message received by the mobile node that has the sequence number value of 1.

Hence, a mobile node, upon receiving a binding acknowledgment message, detects an attempt of traffic redirection if the mobile node has not sent a binding update message corresponding to the received binding acknowledgement message, i.e. the mobile node does not find any binding update with the same sequence number than the received binding acknowledgment message, for which no binding acknowledgment has been received so far.

A further condition should be taken into account by the mobile node when detecting an attempt of traffic redirection, in case the mobile node enters a Proxy Mobile IP home domain. The mobile node should detect an attack only if the received binding acknowledgment message does not correspond to any previously sent binding update message and if the mobile node is not at home, i.e. the prefix announced by an access router to which the mobile node is attached is not the home prefix of the mobile node. The second condition allows to prevent the erroneous detection of an attack when the mobile node enters a PMIP home domain.

Once the mobile node has detected an attack, it sends a new binding update message BU′, which contains the Care-of-Address of the mobile node, to the Local Mobility Anchor LMA to correct the binding cache entry from the saved Care-of-Address of the compromised Mobile Access Gateway to the Care-of-Address of the mobile node.

According to a further embodiment of the invention according to a first aspect, the mobile node may inform the Local Mobility Anchor about the suspected attack, e.g., by setting an “attack flag” in the binding update message BU′. Upon receiving the binding update message BU′, the Local Mobility Anchor can then undertake measures to verify whether an attack really exists and to identify the compromised Mobile Anchor Gateway. This could be done, e.g., by querying the AAA infrastructure to determine from which location the mobile node has recently been authenticated to the network. If this determined location is different from the location of the Mobile Anchor Gateway that sent the proxy binding update PBU, then the Local Mobility Anchor considers that the Mobile Anchor Gateway is compromised. After identifying the compromised Mobile Anchor Gateway, the Local Mobility Anchor can remove this Mobile Anchor Gateway from the list of trusted Mobile Anchor Gateways.

A second variant of the first embodiment according to a first aspect will now be described with respect to FIG. 3. The situation described is that the mobile node is now inside a domain implementing a network-based mobility management scheme. The mobile node is attached to a first Mobile Access Gateway MAG1, which thus transmits a proxy binding update message PBU1 to a Local Mobility Anchor LMA to indicate the mobile node attachment. After having accepted the proxy binding update message PBU1, the Local Mobility Anchor LMA then transmits a proxy binding acknowledgment message PBA1 to the Care-of-Address, which is the first Mobile Access gateway MAG1 address contained in the proxy binding update PBU1, to confirm that the Care-of-Address was saved in the binding cache entry of the Local Mobility Anchor LMA.

FIG. 3 illustrates an attempt by a second compromised Mobile Access Gateway MAG2 to redirect traffic destined to the mobile node. The second Mobile Access Gateway MAG2 transmits a bogus proxy binding update message PBU2 to the Local Mobility Anchor LMA. The Local Mobility Anchor updates its binding cache entry correspondingly by replacing the old Care-of-Address corresponding to the first Mobile Access Gateway MAG1 by the new Care-of-Address corresponding to the second Mobile Access Gateway MAG2 contained in the bogus proxy binding update PBU2. The Local Mobility Anchor LMA then sends a proxy binding acknowledgement message PBA2 to the Care-of-Address corresponding to the compromised Mobile Access Gateway MAG2. Further, the Local Mobility Anchor LMA transmits a proxy binding acknowledgement message PBA′2 to the Care-of-Address corresponding to the first Mobile Access Gateway MAG1 previously saved in the binding cache entry, in addition to the proxy binding acknowledgment message PBA2 sent to the newly saved Care-of-Address corresponding to the compromised Mobile Access Gateway MAG2.

The first Mobile Access Gateway MAG1 can detect an attempt to redirect traffic by the compromised Mobile Access Gateway MAG2 by comparing the received proxy binding acknowledgment message PBA′2 and the proxy binding update messages that the first Mobile Access Gateway MAG1 previously sent to the Local Mobility Anchor LMA. If the first Mobile Access Gateway MAG1 notices a proxy binding acknowledgment message that does not correspond to any proxy binding update message that it sent to the Local Mobility Anchor LMA, then the first Mobile Access Gateway MAG1 checks whether the mobile node is still attached to the first Mobile Access Gateway MAG1. If this is the case, it detects a potential attempt of redirecting traffic by a compromised Mobile Access Gateway.

As shown in FIG. 3, upon receiving the proxy binding acknowledgment message PBA′2, the first Mobile Access Gateway MAG1 notices that it has not sent the corresponding proxy binding update message, since it already has received a proxy binding acknowledgment PBA1 for the previously sent proxy binding update PBU1 and since the sequence number in the proxy binding acknowledgment message PBA′2 differs from that in the proxy binding update PBU1. The first Mobile Access Gateway MAG1 then checks whether the mobile node is still attached to the first Mobile Access Gateway MAG1, as shown by the “test layer 2 attach” signaling in FIG. 3. If the mobile node is still attached to the first Mobile Access Gateway MAG1, it detects an attack from the second Mobile Access Gateway MAG2.

Once the first Mobile Access Gateway MAG1 has detected an attack, it sends a new proxy binding update message PBU′ to the Local Mobility Anchor to correct the binding cache entry at the Local Mobility Anchor. Furthermore, the first Mobile Access Gateway MAG1 may inform the Local Mobility Anchor about the suspected attack, e.g., by setting a new “attack flag” in the proxy binding update message PBU′. The Local Mobility Anchor can then undertake measures to verify whether an attack really exists or not and to identify the compromised Mobile Access Gateway. This could be done by querying the AAA infrastructure to determine from which location the mobile node has been authenticated to the network. After identifying the compromised Mobile Access Gateway, the Local Mobility Anchor can remove this Mobile Access Gateway from the list of trusted Mobile Access Gateways.

In the method illustrated with respect to FIG. 2 resp. FIG. 3, if the binding acknowledgment message BA′ resp. the proxy binding acknowledgment message PBA′2 to the old Care-of-Address or the mobile node resp. the first Mobile Access Gateway MAG1 gets lost, an attack cannot timely be detected. In such case, the attack can only be detected after the next binding update message from the mobile node resp. uncompromised Mobile Access Gateway is followed by a binding update from the compromised Mobile Access Gateway, which can take some time depending on the binding cache entry lifetime. One possible way to speed up the detection in case of packet loss would be to reduce the binding cache entry lifetime. Another option would consist in introducing an acknowledgement message from the mobile node resp. the Mobile Access Gateway for acknowledging the reception of the binding acknowledgment message BA′ resp. the proxy binding acknowledgment message PBA′2, so that the binding acknowledgment message BA′ resp. the proxy binding acknowledgment message PBA′2 can be retransmitted by the Local Mobility Anchor if no acknowledgement is received within a certain time frame.

According to an embodiment of the invention according to a first aspect, the Local Mobility Anchor updates the binding cache entry immediately after receiving the proxy binding update to speed up handover delay. However, in case of a bogus proxy binding update, this would allow temporary redirection of traffic. Hence, the Local Mobility Anchor could create a temporary binding cache entry and set a timer after having sent the binding acknowledgment message BA′ resp. proxy binding acknowledgment message PBA′2 to the old Care-of-Address of the mobile node resp. the first Mobile Access Gateway MAG1. When the timer expires and no binding update resp. proxy binding update message with attack flag has been received, the Local Mobility Anchor can update the binding cache entry with the information from the temporary binding cache entry. This would prevent temporary redirection of traffic, but would increase handover delay.

A second embodiment of the invention according to a first aspect will now be described with respect to FIGS. 4 and 5.

A first variant of the second embodiment according to a first aspect will be described with respect to FIG. 4. A mobile node is located in a domain implementing a client-based mobility management scheme. The mobile node thus communicates its position by sending a binding update message BU to a Local Mobility Anchor LMA. The Local Mobility Anchor LMA first checks authentication information contained in the binding update message BU to identify that this binding update BU has really been sent by the mobile node corresponding to the home address contained in the BU. After having accepted the binding update, the Local Mobility Anchor LMA then transmits a binding acknowledgment message BA to the Care-of-Address of the mobile node contained in the binding update message BU to confirm that the Care-of-Address was saved in the binding cache entry of the Local Mobility Anchor LMA.

FIG. 4 illustrates an attempt by a compromised Mobile Access Gateway in a domain implementing a network-based mobility management scheme to redirect traffic destined to the mobile node. The Mobile Access Gateway transmits a bogus proxy binding update message PBU to the Local Mobility Anchor LMA. The Local Mobility Anchor updates its binding cache entry correspondingly by replacing the old Care-of-Address of the mobile node by the new Care-of-Address of the Mobile Access Gateway contained in the bogus proxy binding update PBU. The Local Mobility Anchor LMA then sends a proxy binding acknowledgement message PBA to the Care-of-Address of the compromised Mobile Access Gateway. Further, the Local Mobility Anchor LMA transmits a binding acknowledgement BA′ to the Care-of-Address of the mobile node previously saved in the binding cache entry, in addition to the proxy binding acknowledgment message PBA sent to the newly saved Care-of-Address of the compromised Mobile Access Gateway.

In this variant of the second embodiment of the invention according to a first aspect, the Local Mobility Anchor requests a new binding update message from both the Care-of-Address currently saved in the binding cache entry and the Care-of-Address in the received PBU or BU message. This request can be realized by sending different types of messages, such as e.g. a proxy binding acknowledgement message PBA and a binding acknowledgment message BA′, or, alternatively, mobility header signaling request messages (MHSR), as specified in B. Haley, Sri Gundavelli, “Mobility Header Signaling Message”, draft-haley-mip6-mh-signaling-02.txt, March 2007. Additionally, a Binding Refresh Advise option (BRA, see Section 6.2.4 in RFC3775) can be included. Setting a value equal or close to zero, preferably less than 5 seconds, for the refresh interval field in the binding refresh advice option or for the lifetime field in the binding acknowledgment message requests the respective receivers of the proxy binding acknowledgement message PBA, the compromised Mobile Access Gateway, and that of the binding acknowledgment message BA′, the mobile node, to reply immediately with a proxy binding update PBU′ and a binding update BU′, respectively, in order to update the binding cache entry in the Local Mobility Anchor.

As shown in FIG. 4, upon receiving the binding acknowledgment message BA′ with or without Binding Refresh Advise option, the mobile node responds with a new binding update BU′ to the Local Mobility Anchor. As mentioned above, the binding acknowledgment message BA′ could be replaced by a mobility header signaling request message, even though FIG. 4 describes the particular example of a binding acknowledgment message. A Mobile Access Gateway that receives a proxy binding acknowledgement message PBA or a mobility header signaling request with or without a Binding Refresh Advise checks whether the mobile node is still attached and sends a new proxy binding update to the Local Mobility Anchor if this is the case. If the mobile node is not attached anymore, it does not send a new proxy binding update. However, since the Mobile Access Gateway MAG is compromised, it responds with a proxy binding update PBU′ although the mobile node is not attached thereto, in order to keep the redirection attack active.

Hence, the Local Mobility Anchor LMA receives both a proxy binding update PBU′ and a binding update message BU′ as a response to its retransmission request. The Local Mobility Anchor thus detects that there is a compromised Mobile Access Gateway.

According to a first option, the Local Mobility Anchor LMA trusts the mobile node rather than the Mobility Anchor Gateway, because there is a peer-to-peer security association between the mobile node and the Local Mobility Anchor LMA and the mobile node itself is the source of the binding update message BU′. As a result, the Local Mobility Anchor discards the proxy binding update PBU′ and considers the Mobile Access Gateway as compromised, meaning that no further proxy binding updates from this Mobile Access Gateway will be accepted.

According to a second option, the Local Mobility Anchor LMA consults a policy store from the AAA infrastructure to verify where the mobile node is authenticated and authorized to use access resources. After the Local Mobility Anchor LMA verifies that the mobile node is not in the PMIP domain, the Local Mobility Anchor LMA considers the Mobile Access Gateway to be compromised.

A second variant of the second embodiment according to a first aspect will now be described with respect to FIG. 5.

The situation described is that the mobile node is now inside a domain implementing a network-based mobility management scheme. The mobile node is attached to a first Mobile Access Gateway MAG1, which thus transmits a proxy binding update message PBU1 to a Local Mobility Anchor LMA to indicate the mobile node attachment. After having accepted the proxy binding update message PBU1, the Local Mobility Anchor LMA then transmits a proxy binding acknowledgment message PBA1 to the Care-of-Address corresponding to the first Mobile Access gateway MAG1 contained in the proxy binding update PBU1 to confirm that the Care-of-Address was saved in the binding cache entry of the Local Mobility Anchor LMA.

FIG. 5 illustrates an attempt by a second compromised Mobile Access Gateway MAG2 to redirect traffic destined to the mobile node. The second Mobile Access Gateway MAG2 transmits a bogus proxy binding update message PBU2 to the Local Mobility Anchor LMA. The Local Mobility Anchor updates its binding cache entry correspondingly by replacing the old Care-of-Address corresponding to the first Mobile Access Gateway MAG1 by the new Care-of-Address corresponding to the second Mobile Access Gateway MAG2 contained in the bogus proxy binding update PBU2. The Local Mobility Anchor LMA then sends a proxy binding acknowledgement message PBA2 to the Care-of-Address corresponding to the compromised Mobile Access Gateway MAG2. Further, the Local Mobility Anchor LMA transmits a proxy binding acknowledgement message PBA′2 to the Care-of-Address corresponding to the first Mobile Access Gateway MAG1 previously saved in the binding cache entry, in addition to the proxy binding acknowledgment message PBA2 sent to the newly saved Care-of-Address corresponding to the compromised Mobile Access Gateway MAG2.

In this variant of the second embodiment of the invention according to a first aspect, the Local Mobility Anchor sends either a mobility header signaling request or, as illustrated in FIG. 5, a proxy binding acknowledgement message PBA2 to the Care-of-Address corresponding to the compromised Mobile Access Gateway MAG2 and a proxy binding acknowledgment message PBA′2 to the Care-of-Address corresponding to the first Mobile Access Gateway MAG1, with or without a Binding Refresh Advise option (BRA, see Section 6.2.4 in RFC3775).

Whenever a mobile access gateway receives a request for retransmission, the mobile access gateway performs a check to determine whether the mobile node is still attached thereto. If the mobile node is still attached, then the mobile access gateway sends a proxy binding update to the Local Mobility Anchor. The compromised Mobile Access Gateway MAG2 sends a proxy binding update PBU′2 to the Local Mobility Anchor to keep the redirection attack active, and the first Mobile Access Gateway MAG1, in case of attachment of the mobile node, replies with a proxy binding update PBU′1, in order to update the binding cache entry in the Local Mobility Anchor.

As described above, the Local Mobility Anchor receives 2 proxy binding updates, upon which the Local Mobility Anchor LMA determines that one of the Mobile Access Gateways is compromised. Next, the Local Mobility Anchor LMA can consult the policy store of the AAA infrastructure as described above in order to identify the compromised Mobile Access Gateway.

As mentioned above with respect to the first embodiment according to a first aspect, the Local Mobility Anchor LMA could update the binding cache entry immediately after receiving a proxy binding update to speed up handover delay. However, this would allow temporary redirection of traffic by a compromised Mobile Access Gateway. Hence, the Local Mobility Anchor could create a temporary binding cache entry with the new Care-of-Address and set a timer after having sent the binding acknowledgment resp. proxy binding acknowledgment message to the current Care-of-Address in the binding cache entry. When the timer expires and no binding update resp. proxy binding update message was received from the current Care-of-Address, the Local Mobility Anchor updates the binding cache entry with the information from the temporary binding cache entry. The Local Mobility Anchor thus assumes that the new Care-of-Address comes from a non-compromised Mobile Access Gateway. This alternative would prevent temporary redirection of traffic, but increase handover delay.

Even though the first aspect of the invention has been described in particular with a situation where the Local Mobility Anchor transmits a binding acknowledgment message to either the mobile node or a Mobile Access Gateway, other types of messages to detect attacks can be used from the ones described, without departing from the scope of the invention.

In the following, a second aspect of the invention will be described. The following terms will be construed as having the following definitions.

A Binding Update (BU) is herewith defined as a registration message sent by a mobile node or proxy mobility agent (PMA) to notify the mobility anchor point (HA) about the new address (i.e. topological location) of the MN. In this second aspect of the invention, it will be differentiated between BUs send by the MN in host-based mobility mechanism, called further CBU for client-BU, and BUs sent by the PMA in network-based mobility mechanism, called further PBU for proxy-BU. Analogically, a binding update acknowledgement message sent by the host is indicated as CBAck (client-BAck) and binding update acknowledgement message sent by the PMA is indicated as PBAck (proxy-BAck).

A BU race condition herewith refers to a situation, in which a CBU or a PBU message gets delayed, and as consequence an old (P)BU is reaching the HA after a fresher (P)BU.

CMIP (client Mobile IP) refers to a host-based mobility mechanism. The client (host or mobile node, MN) sends registration messages to the mobility anchor node (home agent, HA) in order to register its new location.

PMIP (proxy Mobile IP) refers to a network-based mobility mechanism founded on the Mobile IP protocol (D. Johnson, C. Perkins, J. Arkko, “Mobility Support in IPv6”, RFC 3775, June 2004). The proxy mobile agent (PMA) sends registration messages on behalf of the MN to the mobility anchor node (HA) in order to register the MN's new location. In PMIP mechanism the MN is not involved in the mobility-related procedures.

The solution according to an embodiment of the invention according to a second aspect can be separated into 2 phases. During the first phase, the HA detects the possibility of BU race condition. This phase is further called BU race condition detection procedure. During the second phase, after the HA has detected the possibility of BU race condition, the HA needs to resolve which of both BUs is fresher. This is further called resolution of the freshest BU procedure.

The following terms will be used in the description of the invention according to a second aspect, the definition of which is given in the following.

A BU resolution query message designates a message sent by the HA to resolve the freshest (i.e. the most current) BU in case that BU race condition occurred. This message could be a binding update acknowledgement with Refresh Advise option or an Internet Control Message Protocol (ICMP) echo message or a Care-of Test Init (CoTI) message or some other message.

A BU resolution reply message designates a message sent by the MN or by the PMA as reply to BU resolution query message. This message could be a binding update or a proxy binding update message or ICMP echo reply message or Care-of Test (CoT) message or some other message.

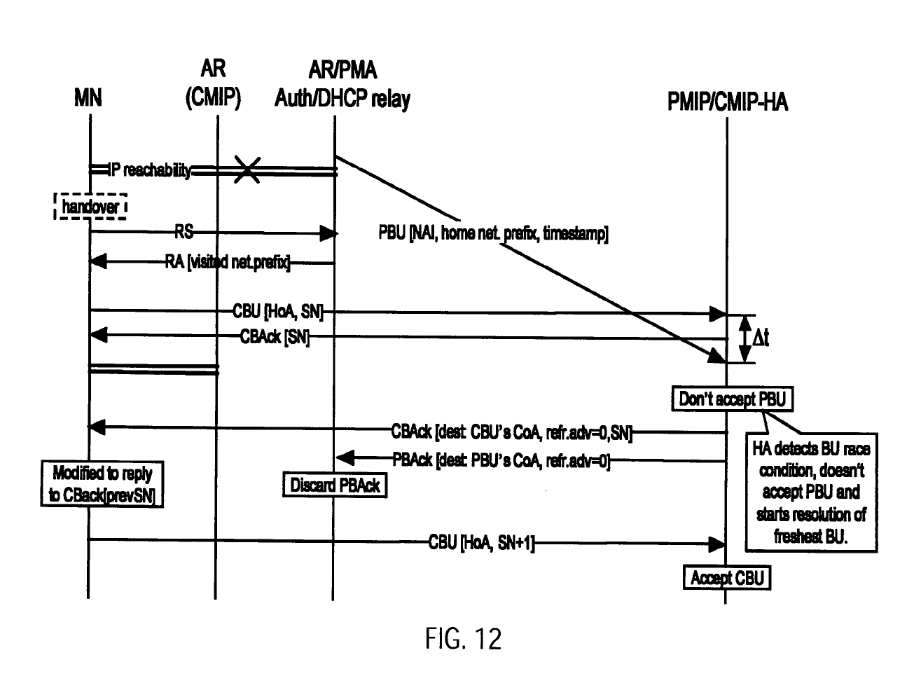

The BU race condition detection procedure is mainly based on the detection of the change of used mobility mechanism, i.e. the transition from client-based (CMIP) to network-based (PMIP) mobility or vice versa. The HA can detect this transition by the consecutive reception of BUs of different types, e.g. reception of CBU after having received PBU or reception of PBU after having received CBU. If the HA would start the resolution of freshest BU procedure every time a transition of the mobility mechanism is detected, this would result in unnecessary signalling in the network and unnecessary delay in the processing of the binding updates in the HA. Therefore, according to a preferred embodiment of the invention according to a second aspect, the BU race condition detection procedure is refined and an additional more precise condition for the BU race condition detection is introduced by having the HA monitoring and storing the time when RI is of different types arrive. If the arrival of consecutive BUs of different types is within a pre-configured time-span (further the time-span is denoted by “T”), this means that the BUs of different types are sent very shortly after each other, then the possibility of BU re-ordering is considerable. In this case the HA triggers resolution of freshest BU procedure. Let us assume the measured time difference in FIG. 12. Now, if the condition that Δt is smaller/shorter then the pre-configured time-span T (i.e. Δt<T) is fulfilled, then HA starts the resolution of freshest BU procedure.

The configuration of the time-span T can be done manually by the network operator or it can be determined dynamically. For example the operator may know how long is the handover procedure between a foreign and home network (or CMIP-based to PMIP-based mechanisms) or it knows the minimum time needed for handover between different network domains. So, the arrival of a consecutive BUs of different types cannot be shorter than the minimum handover delay. If the time is shorter, then something suspicious happened and the HA doubts about the correct consequence of arrival of BUs. In this case the parameter T is configured based on the minimum handover delay for CMIP-to-PMIP (or vice versa) mobility transition plus or minus some guard time. However, if the MN performs pre-authentication and pre-authorisation (meaning that the MN performs the EAP procedures with the new network domain before the L2 handover), then the parameter T needs to be set up appropriately, i.e. to consider that the BUs of different type may be sent shortly after each other. Note that the parameter T is an additional condition for BU race condition detection procedure and its configuration is implementation-specific. If the HA detected a BU race condition, the next step is to perform resolution of the freshest BU procedure. During this procedure the HA rejects the last received BU (CBU or PBU, further called C/PBU) and sends BU resolution query message (e.g. binding acknowledgement with Refresh Advise option set to 0, BAck[Refr-Adv-Opt=0]) to both CoAs. The first CoA is taken from the current binding cache entry (BCE) meaning that this is the address being already registered by the previous C/PBU. The second CoA is contained in recent C/PBU, which has just been rejected. As a respond to BU resolution query message, the HA receives only one BU resolution reply message (e.g. C/PBU) from the current MN's location, i.e. from the freshest CoA, and updates its BCE correspondingly.

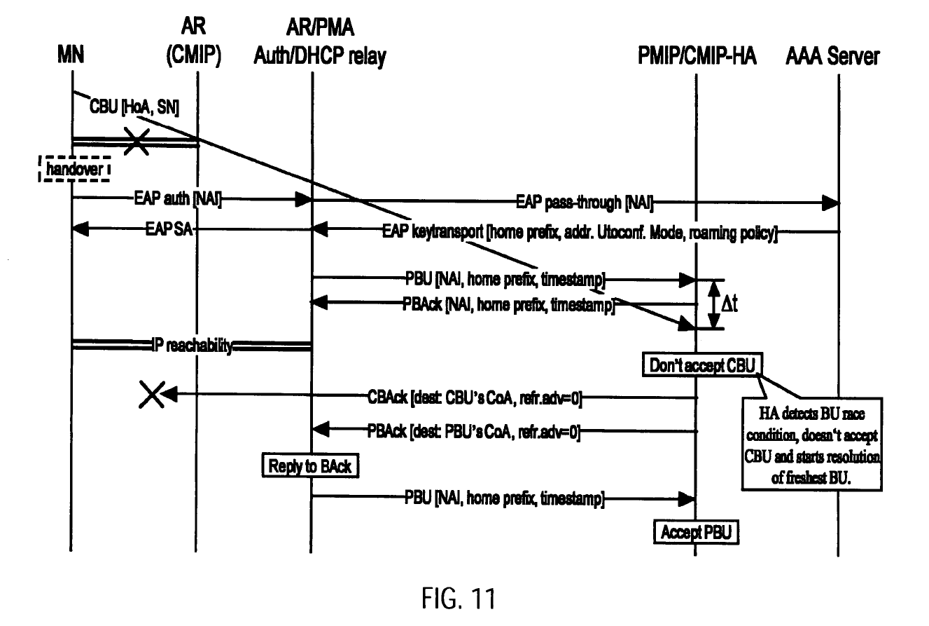

FIG. 11 shows an exemplary solution of the BU race condition scenario in CMIP-to-PMIP mobility transition. An older CBU sent by the MN arrives at the HA later than a fresher PBU sent by the PMA. Since the time difference (Δt) of the arrival of PBU and CBU is smaller than the pre-configured time parameter T, the HA detects a possibility of BU race condition. Therefore the HA doesn't accept the CBU and initiates the resolution of freshest BU procedure. One option for the HA is to delete the CBU, but another option (as it is shown later in the description in the part where the HA receives de-registration message before receiving BU resolution reply message) is to store the information of the CBU, since the HA may take a decision for updating the BCE before the reception of BU resolution reply message. As a consequence of detecting BU race condition, the HA sends CBAck[Refr-Adv-Opt=0] to the MN and PBAck[Refr-Adv-Opt=0] to the PMA. The CBAck[Refr-Adv-Opt=0] to the MN cannot be received, so no reply would come from the MN. After the reception of PBAck[Refr-Adv-Opt=0] the PMA responds immediately with a PBU to the HA. When the HA receives the PBU, it updates its BCE. In this case it means that the BCE is not changed, just the lifetime timer in the BCE is updated.

FIG. 12 shows an exemplary solution of the BU race condition scenario in PMIP-to-CMIP mobility transition. An older PBU sent by the PMA arrives at the HA later than a fresher CBU sent by the MN. Again if the condition Δt<T is fulfilled, the HA initiates the resolution of freshest BU procedure. HA sends CBAck[Refr-Adv-Opt=0] to the MN and PBAck[Refr-Adv-Opt=0] to the PMA. The PBAck[Refr-Adv-Opt=0] to the PMA is received, but the PMA discards the message because MN is not anymore present in the PMA's mobility registration database. On the other hand, after the reception of CBAck[Refr-Adv-Opt=0] message, the MN responds immediately with a CBU to the HA. When the HA receives the CBU, it updates its BCE. In this case it means that the BCE is not changed, just the lifetime timer in the BCE is updated.

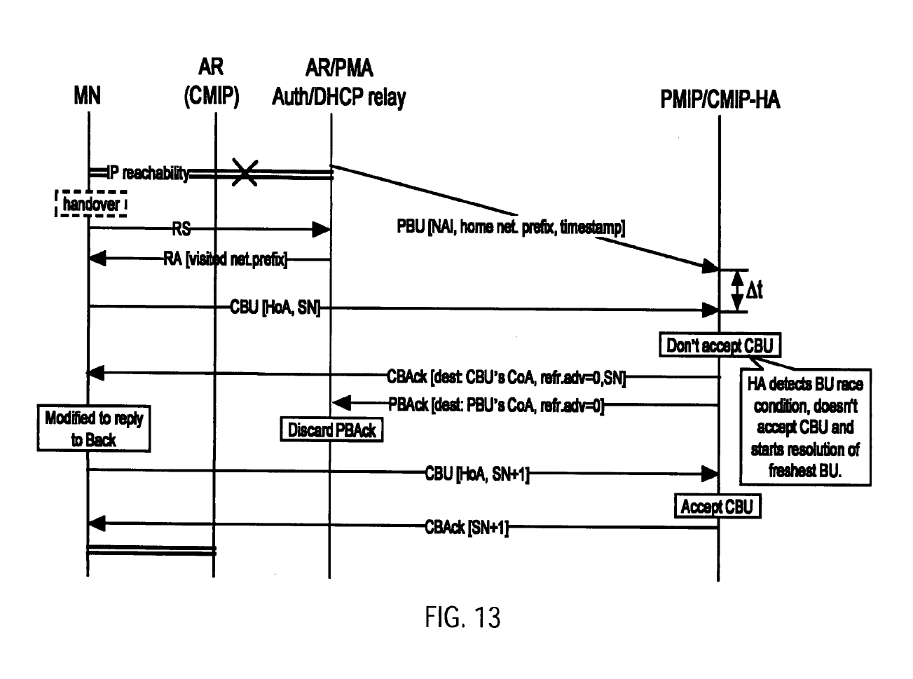

As it is described in the previous paragraphs, a refinement of the detection of BU race condition is based on the time difference of the arrival of consecutive BUs of different types. In contrast to FIG. 12, it is also possible that BUs arrive in-order, however, in a very short time after each other. Such case is depicted in FIG. 13 where MN performs PMIP to CMIP handover. The PBU arrives shortly before the CBU (i.e. Δt<T). Having this condition, the resolution of freshest BU procedure will be activated although the BUs arrived correctly (in-order). The resulting behaviour is that the HA doesn't accept the latest BU (i.e. CBU) and sends CBAck[Refr-Adv-Opt=0] to MN and PBAck[Refr-Adv-Opt=0] to PMA. The PMA discards the PBAck[Refr-Adv-Opt=0] message, since the MN is not any more attached to it. After the reception of CBAck[Refr-Adv-Opt=0], the MN responds immediately with a CBU[SN+1] to the HA. The denotation CBU[SN+1] means that the sequence number in the client-BU is increased by one. When the HA receives the CBU, it accepts the CBU and updates its BCE, as the corresponding proxy-BCE for this MN is de-activated (or deleted depending on the implementation). The HA may send CBAck back to the MN for acknowledgement of the CBU. To summarize the case of FIG. 13, the resolution of freshest BU procedure is triggered although the BUs arrive in-order at the HA. However, the HA accepts the correct BU (in this case CBU) after resolution of freshest BU procedure is performed. So, the correct processing is not influenced. The only impact is that a small delay is introduced before the CBU is accepted. This delay is one round-trip-time (RTT) between HA and MN.

In the following, an optimization of the resolution of freshest BU procedure according to a second aspect will be described, said optimization being mainly at the level of the PMA.

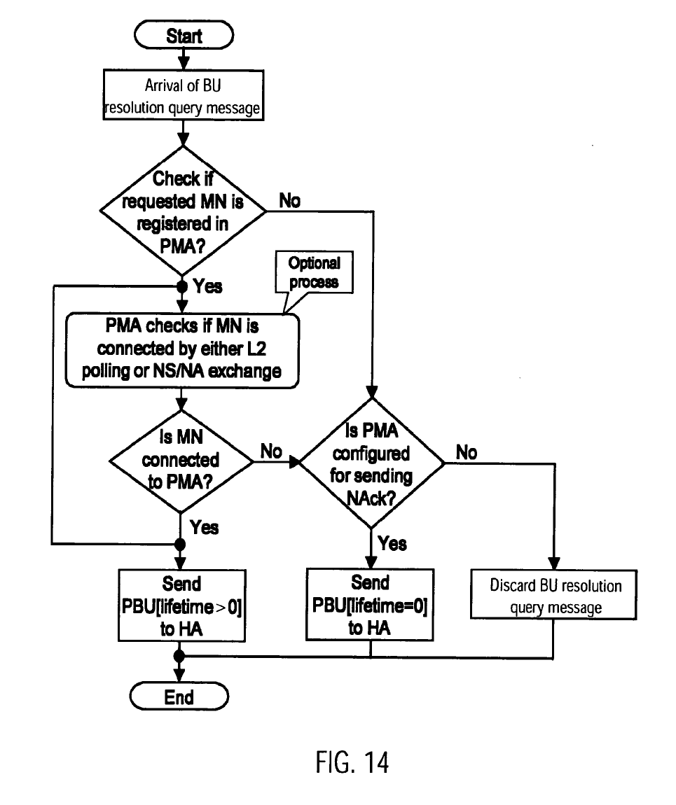

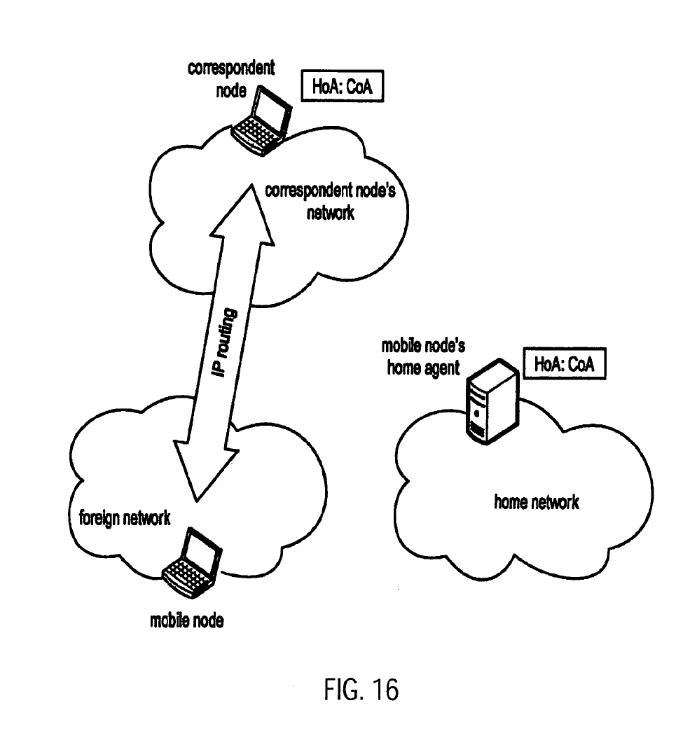

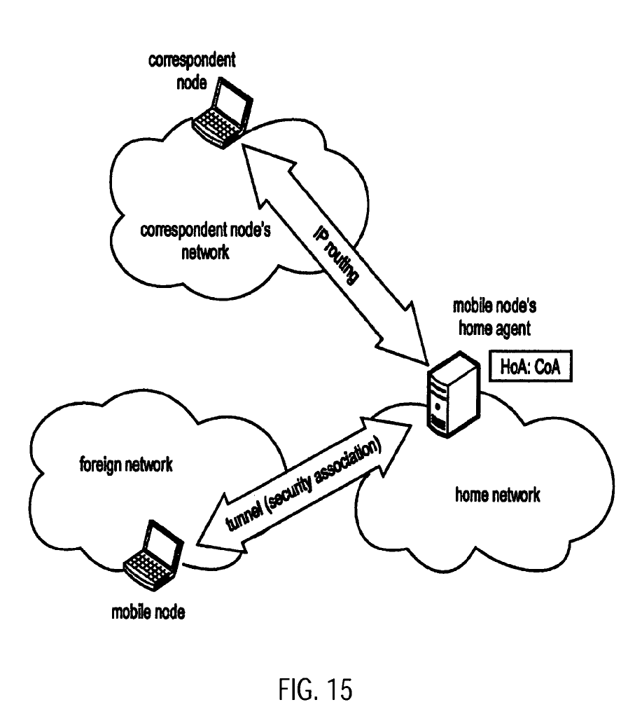

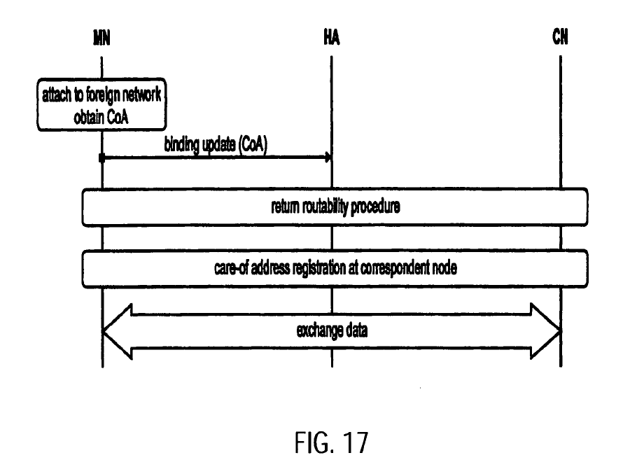

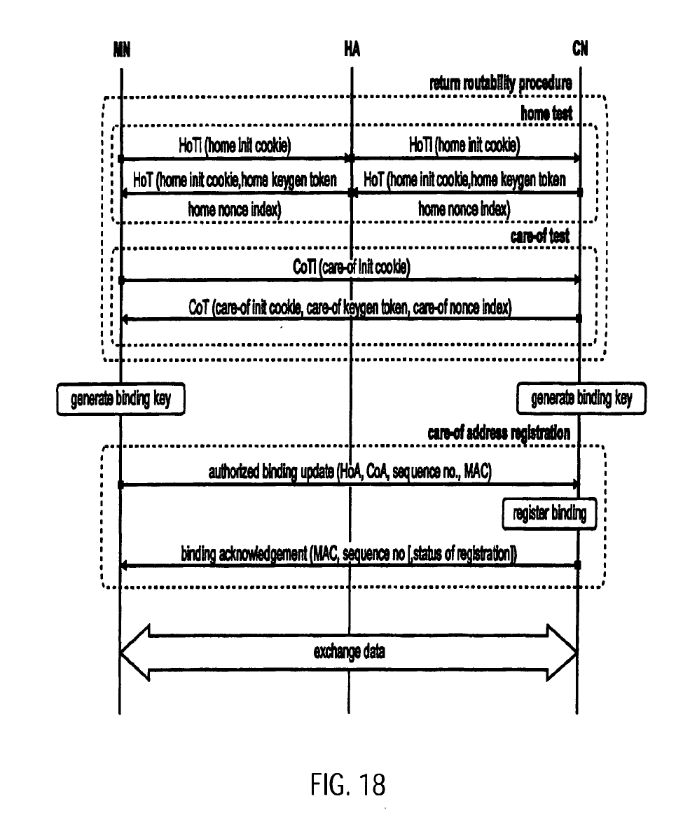

Under some circumstances, the layer 2 (L2) technology between PMA and MN may not support L2 de-registration. This means when the MN leaves the PMA, for a short time duration the PMA may still have entry in its database where the MN is registered. If the PMA receives a BU resolution query message during this time duration, the PMA would respond positively to the HA, although the MN is away. Therefore the following optimization is suggested, which is illustrated by the flowchart in FIG. 14.

According to an embodiment of the invention according to a second aspect, if the PMA receives a BU resolution query message for a given MN and the PMA has a valid registration for this MN, the PMA checks if the MN is still attached to the IP link. There are several options to do this. One option is to send a L2 polling message to the MN and obtaining a reply. Another option for the HA is to send Neighbor Solicitation and receive Neighbor Advertisement from the MN. If the PMA determines that the MN is still attached, then the PMA sends a positive PBU (with non-zero lifetime option) to the HA. Otherwise, if the MN is not attached to the PMA, the PMA discards the BU resolution query message.

It is also possible that the PMA always answers to BU resolution query message. Hence, according to a second option, if the MN is registered in the PMA, the PMA answers with a positive BU resolution reply message. If the MN is not anymore attached to the PMA, the PMA answers with a negative BU resolution reply message.

Preferably, the BU resolution query message is implemented by be binding update acknowledgement message with Refresh Advise option. The Refresh Advise option is set to zero which means that the recipient must immediately respond with a binding update. The denotation of this message used in the second aspect of the invention is PBAck[Refr-Adv-Opt=0]. The resulting BU resolution reply message is preferably a CBU or PBU depending who responds to the PBAck[Refr-Adv-Opt=0] message: if the responder is the MN then the BU resolution reply message is CBU and if the responder is PMA, the BU resolution reply message is PBU. A positive BU resolution reply message is a normal CBU or PBU having a lifetime option bigger than zero (i.e. PBU[lifetime>0]). A negative BU resolution reply message is a CBU or PBU having a lifetime option equal to zero (i.e. PBU[lifetime=0]).

FIG. 14 shows an exemplary implementation according to a second aspect of the invention in the PMA for supporting the resolution of freshest BU procedure. In the simplest implementation, the PMA checks only the database (BCE), if the MN is registered (has an entry). If the MN has an entry in the BCE list, the PMA sends PBU[lifetime>0] meaning that the binding lifetime in the BCE should be updated with the value in the lifetime option. On contrary, if the MN is not in the BCE, the PMA discards the BU resolution query message. If the PMA is configured to send NAck message (i.e. a deregistration message BU[lifetime=0]), then the PMA sends this message if the MN is not present in BCE list. In MIPv6 the deregistration message is a BU[lifetime=0], which deletes the MN's entry for a given CoA in the HA. Here, the PMA sends PBU[lifetime=0] in order to deregister the proxy binding in the HA with the PMA itself, or with other words, the PMA informs the HA that the MN is not any longer located at this PMA. Optionally, if the MN is present in the BCE list, but the PMA is configured to perform L2 availability check, the PMA performs this check. If the L2 check is positive, than the PMA sends a PBU[lifetime>0]. Otherwise if the L2 check is negative, the PMA performs the same operation as if the MN is not available in the BCE list.

In the following, another embodiment of the invention according to a second aspect will be described. If the HA receives CBU or PBU de-registration message this means that the one of both CoAs is not any longer valid. The de-registration process in CMIP-HA is described in section 10.3.2. of “D. Johnson, C. Perkins, J. Arkko, “Mobility Support in IPv6”, RFC 3775, June 2004”. A binding in the HA may need to be de-registered when the MN returns in the home network or when the PMA detects that the MN has left its area. BU deregistration message is sent in any case when the sending entity (MN or PMA) knows that the CoA is not needed or not valid anymore. Therefore, when the HA receives CBU or PBU de-registration message, the HA should cancel the BU race condition detection procedure or resolution of the freshest BU procedure. Specifically in case of BU race condition detection procedure, the HA may stop measuring the Δt time. In case of resolution of the freshest BU procedure, if the HA receives a de-registration message after having sent BU resolution query message and before receiving BU resolution reply message, the HA decides about the validity of the most current BU based on the deregistration message without waiting for BU resolution reply message. For example, if HA has received PBU after a CBU and has started the resolution of the freshest BU procedure and receives a de-registration CBU, then the HA decides to accept the PBU and delete its binding from the CBU before BU resolution reply message arrives. Vice versa, if HA has received CBU after a PBU and has started the resolution of the freshest BU procedure and receives a de-registration PBU, then the HA decides to accept the CBU and delete the binding from the PBU before BU resolution reply message arrives.

The changes required to be implemented in the HA in order to deploy the solution of this invention according to a second aspect will be summarized in the following.

Firstly, the BU race condition detection procedure described above should be implemented in the HA. Further, the time parameter “T” as defined above should be configured by the network operator. There are two options of implementing the measurement of the time difference between arrival of BUs of different type. One option is to store the arrival time of every PBU and CBU in the HA. This could be implemented, according to an embodiment according to a second aspect, as a new field in the Binding Cache Entry (BCE) in the HA. When a new BU of different type arrives, the HA compares the arrival time of the newest C/PBU and previous C/PBU. Another option would be to implement a timer to measure the time difference in the arrival of BUs of different types. After a C/PBU arrives the timer is started and stopped when the next C/PBU arrives.

Another required change in the HA is the implementation of the resolution of freshest BU procedure. Further, the transmission of the binding request message BAck[Refr-Adv-Opt=0] to both CoAs or at least one of the CoAs of the MN should be implemented. The newest BU should be stored by the HA until the resolution of freshest BU procedure is completed, and then be discarded.

The changes required at the mobile node and at the PMA will be summarized in the following.

Normally, a node implementing MIP processes a binding acknowledgement (BAck) message only for an outstanding BU. However, the BAck[Refr-Adv-Opt=0] message is a second binding acknowledgement for the same BU received in correspondingly MN or PMA. Therefore, the MIP implementation in MN or PMA should be changed to process a second CBAck or correspondingly PBAck message only if the Refresh Advise option is set to 0 (Refr-Adv-Opt=0). The reason of accepting second C/PBAcks only having option Refr-Adv-Opt=0 is to limit possible security thread where an attacker may want to flood the MN with unnecessary BAcks. One specific example for accepting second CBAck in case of MN is explained in the following. The MN processes only CBAcks having the same sequence number (SN) as outstanding CBUs. Once a CBAck has been processed, the CBU is not anymore outstanding. Therefore, the MN needs to be modified in order to accept a second CBAck for the already acknowledged CBU.

Furthermore, the PMA is changed according to the optimization procedures mentioned above, i.e. sending a negative reply PBU[lifetime=0] to the HA, when the MN is not anymore registered at the PMA. Further, the PMA may be modified to perform polling for the MN each time whether the PMA is not sure about the availability of the MN. In such case of polling, the PMA may send a L2 polling message to the MN and obtain a reply. Another option for the HA is to send Neighbor Solicitation and reception of Neighbor Advertisement from the MN would confirm the attachment of the MN.

There could be a special case, in which both BU resolution query messages got lost for some reason. In such case where no BU resolution reply message to a corresponding BU resolution query message arrives in the HA within a given time, the HA sends the BU resolution query messages again.

According to another embodiment of the invention according to a second aspect, the HA does not send the BU resolution message (i.e. BAck) to both CoAs but to only one entity. For example, the HA may send the BAck only to the PMA, which has been last registered in the HA, or with other words the PMA, which sent last PBU. When the PMA receives the BU resolution message, PMA checks whether the requested MN is still registered. If yes, PMA sends a new PBU to the HA. If not, it sends a negative reply back to the HA. The advantage of this variant is that very probably the round trip time between PMA and HA is smaller. Therefore, the HA receives a fast reply by the PMA. For the realization of this variant, it is needed to modify the PMA to always respond to BU resolution message.

Different variants are possible with respect to the resolution of the freshest BU. In the main solution the deployment of binding acknowledgement with Refresh Advise option was presented. This solution is preferred because the response to the BAck is a BU or PBU, which is signed by the sender, so that the home agent authorizes the sender of the message. In this way the solution of freshest binding update resolution doesn't have security threads. Other options for the home agent to poll the sender of the binding update, i.e. the MN and proxy mobility agent, can however be envisaged. Specifically, alternative messages to a BAck can be transmitted, some of which are listed in the following.

The HA may send a Care of Address Test Initiation (CoTi) message to the CoAs of both consecutive binding updates of different types. The entity receiving the CoTi message replies with a CoT message. When the HA receives the CoT message, it determines the sender based on the CoT's source IP address. Consequently, the HA can derive the present location of the mobile node. However, since a CoT message is not signed, it does not offer optimal security, as the HA cannot differentiate an attacker that may include some different CoAs and disturb the MN's data flow. In this respect, the use of this message is considered possible but less preferred than the use of a BAck.

Alternatively, the HA may send an ICMP echo request to both CoAs or to at least one of the CoAs. Depending on the received reply, the HA can determine the validity of the current CoA. However, it is possible that firewalls filter or discard the ICMP messages in order to avoid flooding attacks. In this respect, the use of this message is considered possible but less preferred than the use of a BAck.

According to another embodiment of the invention according to a second aspect, the principles described above with respect to the embodiments of the invention according to a second aspect may be used in the case of a handover of a mobile node between two PMA's within a PMIP domain. The solution described in the second aspect of the invention targets the problem to choose the freshest BU when the BUs are not directly comparable because they contain either sequence number (CBU) or timestamp (PBU). However, the solution may also be applied to distinguish between PBUs when they come from different PMAs, which are not time synchronized. This may occur when the MN moves between PMIP domains that are not time synchronized. In this case, consecutive PBUs coming from both PMIP domains have timestamp option, but the timestamp is not sufficient to decide about the PBU freshness. In such cases, first the HA should know (e.g. through pre-configuration) about the missing time synchronization of the PMAs sending the PBUs. Second, the HA treats the PBUs coming from those non-synchronized PMAs as BUs from different type. If the BU race condition detection procedure detects race condition, than the HA triggers the resolution of freshest BU procedure.

In the following, a third aspect of the invention will be described.

A definition of several terms frequently used in the description of the third aspect of the invention will be provided.

A security association may be defined as a set of security information that two nodes or functional entities share in order to support secure communication. For example, a security association may include a data encryption algorithm, data encryption key(s) (e.g. a secret key or a public/private key pair, initialization vector(s), digital certificates, etc. Typically, there is a security association provided between a mobile node in a foreign network and its home agent in the home network. Thus, even if the mobile node is attached to a foreign network, encrypted and/or authenticated/authorized communication between the home agent and the mobile node (e.g. through a secured tunnel) may be ensured.

A token is cryptographic information that may be used in security related functions and procedures. By means of one or more tokens the mobile node and the correspondent node may achieve an authorized communication of messages e.g. relating to the registration of a binding for the mobile node at the correspondent node. Tokens may for example be generated using random numbers, so called nonces. One or more tokens may be combined to form a new token.

A keygen token may be a number supplied by a correspondent node in the return routability procedure to enable the mobile node to compute the necessary binding management key for authorizing a Binding Update. Accordingly, a care-of keygen token is a keygen token sent by the correspondent node in the care-of test, while a home keygen token denotes a keygen token sent by the correspondent node in the home test.

A binding management key (Kbm) is a key used for authorizing a binding cache management message (e.g., Binding Update or Binding Acknowledgement). Return routability provides a way to create a binding management key.

Nonces are typically used internally by the correspondent node in the creation of keygen tokens related to the return routability procedure. The nonces are not specific to a mobile node, and are kept secret within the correspondent node. A nonce index is used to indicate which nonces have been used when creating keygen token values, without revealing the nonces themselves.

A cookie is a random number used by a mobile node to prevent spoofing by a bogus correspondent node in the return routability procedure. A care-of init cookie is a cookie sent to the correspondent node in the care-of test init message. This care-of init cookie may be returned in the care-of test message so as to allow the mobile node checking the authenticity of the response. Similarly, a home init cookie is a cookie sent to the correspondent node in the home test Init message, to be returned in the home test message.

A registration of a care-of address is a process during which a mobile node sends a binding update to its home agent or a correspondent node, causing a binding for the mobile node to be registered. The return routability procedure may precede a registration and may be used to authorize the subsequent registration by the use of a cryptographic token exchange.

Typically, the binding update being authorized is referred to as an authorized binding update. Generally, an authorized binding update may be considered a binding update comprising some cryptographic information such as a message authentication code for authenticating the binding update. As indicated above, the authorized binding update may comprise a message authentication code that may be for example generated based on the cryptographic information exchanged between a correspondent node and a mobile node in a return routability procedure.

In general, the use of a message authentication code incorporated to a message may provide a way to check the integrity of information transmitted over or stored in an unreliable medium, such a s a communication path or connection. Typically, mechanisms that provide such integrity check based on a secret key are usually called message authentication codes (MAC). Typically, message authentication codes are used between two parties that share a secret key in order to validate information transmitted between these parties. MAC mechanisms may be for example based on cryptographic hash functions (e.g. MD5 and SHA1). Furthermore, the secret key employed may be cryptographic information that may for example also be generated using a cryptographic hash function. Details on cryptographic hash function used in an embodiment of the invention may for example be found in H. Krawczyk et al., “HMAC: Keyed-Hashing for Message Authentication”, IETF RFC 2104, February 1997, available at http://www.ietf.org and incorporated herein by reference.

A return routability is a procedure including an exchange of cryptographic information between a mobile node and a correspondent node based subsequently exchanged messages can be authorized. In one embodiment the return routability procedure is similar to the MIPv6 return routability procedure in that it comprises a home test and a care-of test providing the mobile node with two tokens (denoted home keygen token and a care-of keygen token) for authenticating a subsequent binding update of the mobile node. However, as will become apparent from the following sections, in some embodiments of the invention this procedure is changed, so that no home test is required (or in other words the home test could be “skipped”). Further, in other embodiments, no return routability procedure is required for the authentication of a binding acknowledgment.

As already indicated above, one goal of the invention is to enable a mobile node to detect when its binding cache entry at the correspondent node has been spoofed. The detection of a spoofed binding cache entry for the mobile node at the correspondent node may for example allow for undertaking countermeasures immediately so as to revoke the effects of the attack (for example repairing the binding at the correspondent node).

Multiple mechanisms to detect attacks on a mobile node's binding will be outlined herein. In one embodiment according to the third aspect of the invention, the detection mechanism includes the correspondent node sending multiple binding acknowledgements to different addresses of the mobile node after receiving an authorized binding update. In addition to or instead of sending the binding acknowledgement to the mobile node's new care-of address, the correspondent node may send a binding acknowledgement to mobile node's home address and/or to the old care-of address. Consequently, the mobile node would receive a binding acknowledgement although it may not have sent the corresponding binding update, which can be interpreted by the mobile node as a successful attack on its binding entry in the correspondent node. In one exemplary embodiment, the mobile node may stay connected/attached to the network where its care-of address deregistered by the authorized binding update is defined to receive the binding acknowledgement destined to this care-of address before (optionally) detaching therefrom.

In another embodiment according to the third aspect of the invention, the detection mechanism includes the mobile node checking the correctness of the binding entry in the correspondent node using a binding test. This test could for example include sending one or more binding test messages to the correspondent node. The binding test messages may require a reply from the correspondent node (e.g. similar to an ICMP echo request/response). The mobile node may for example send these binding test messages once, periodically or occasionally, e.g. when no data has been received by the correspondent node for a certain amount of time. The binding test messages may be for example tunneled via the mobile node's home agent, so that they have mobile node's home address as source address and the correspondent node must use the binding cache entry for the reply. If no reply is received after sending multiple test messages the mobile node may interpret the missing response as an indication for a successful attack on its binding at the correspondent node.

In a further embodiment of the invention according to the third aspect of the invention, the detection of a spoofed binding cache entry at the correspondent node may comprise the correspondent node sending unsolicited probe messages to the current care-of address of the mobile node. The probe messages may for example be sent by the correspondent node to the mobile node for a certain amount of time, periodically or occasionally. A probe message may for example be a binding acknowledgement message. If no data and/or no binding acknowledgements are received for multiple time periods, the mobile node could interpret this as an indication for a successful attack on its binding cache entry at the correspondent node.

Those detection mechanisms may be used in addition to existing binding procedures to make them more secure or it can be used to optimize the binding procedure in a way that reduces signaling overhead and handover delay at the cost of not preventing all attacks in the first place. However, a decrease of security is prevented, since the mobile node may be able to detect the attack and undertake actions immediately to revoke the effects of the attack. Further, the different detection mechanism can be employed individually or in arbitrary combination.

Another goal of the third aspect of the invention relates to an optimization of the return routability procedure and route optimization mode so that for example no cryptographically generated addresses are required. In one embodiment according to the third aspect of the invention, home test may be executed by the mobile node and correspondent node only initially and the home keygen token is re-used in subsequent optimistic return routability rounds, i.e. the home test (HoT/HoTi exchange) is skipped. This may reduce signaling overhead and handover delay, but facilitates time shifting attacks on a mobile node's binding at a correspondent node. However, this drawback may for example be compensated by the mobile node detecting attacks using one of the different mechanisms described herein. In response to detecting an attack, the mobile terminal may for example initiate a full return routability procedure (incl. home test/home test init exchange) to repair the binding immediately and to generate a new home keygen token.

As indicated above, in an embodiment according to the third aspect of the invention, an attacker spoofing a binding cache entry of a mobile node may be detected based on the correspondent node sending multiple binding acknowledgements to different addresses of the mobile node after receiving an authorized binding update. For example in addition to sending a binding acknowledgement to the mobile node's new care-of address, correspondent node sends a binding acknowledgement to mobile node's home address and/or optionally to the old care-of address.

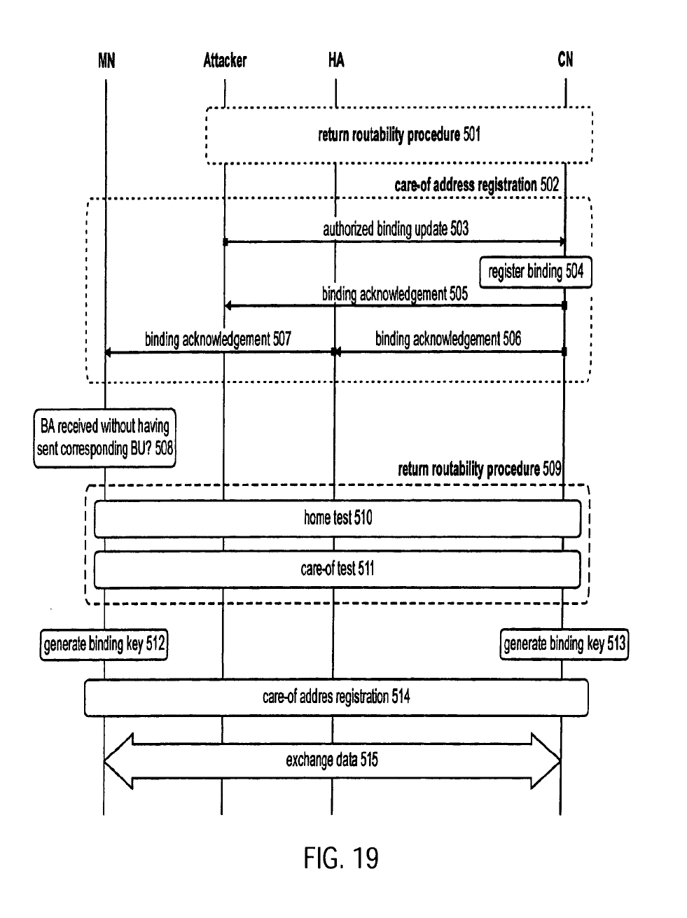

FIG. 19 shows an exemplary sequence of messages exchanged between an attacker, a mobile node, a correspondent node and a home agent allowing the mobile node to detect an attack on its binding at the correspondent node based on binding acknowledgement sent via the mobile node's home network according to an exemplary embodiment of the invention. For exemplary purposes it is assumed that mobile node and correspondent node use route optimization for exchanging data packets.

For exemplary purposes only it is further assumed that the attacker performs an address stealing/impersonation attack for example to eavesdrop or tamper the data destined to the mobile node. The attacker may thus manage to perform 501 a return routability procedure and a subsequent care-of address registration procedure 502 with the correspondent node (CN). Upon having obtained the relevant cryptographic information for authenticating a binding update as a result of the return routability procedure, the attacker may subsequently transmit 505 a binding update to the correspondent node to register for example its own address as a care-of address for the mobile node to redirect the traffic destined to the mobile node's care-of address to itself. As the attacker is capable of validly authenticating the binding update (e.g. by including a message authentication code determined based on the cryptographic information obtained from the return routability procedure 501), the correspondent node will register 503 the address in the binding update as the new care-of the address of the mobile node (i.e. updates the binding cache entry for the mobile node's home address so as to point to the new, spoofed care-of address).

In addition to (or instead of) sending 505 a binding acknowledgment to confirm the registration of the new care-of address to the new care-of address indicated in the authorized binding update, the correspondent node sends 506 a (further) binding acknowledgment to the mobile node's home address so that the binding acknowledgment is routed to the home agent of the mobile node first, which forwards 507 the binding acknowledgement to the mobile node using the care-of address of the mobile node register at the home agent's binding cache (i.e. the actual, non-spoofed care-of address of the mobile node).

Consequently, the mobile node receives a binding acknowledgement although it has not sent the corresponding binding update, which can be interpreted by the mobile node as a successful attack on its binding entry in the correspondent node. More specifically, the mobile node may for example detect 508 an attack on its binding at the correspondent node, when a binding acknowledgement is received with a sequence number that is not within the retransmission window (i.e., higher or by a certain threshold lower than the sequence number) of the last (unacknowledged) binding updates sent to this correspondent node.

It should be further noted that in a variation of the embodiment according to the third aspect of the invention, the correspondent node could also send a binding acknowledgment to the mobile node's previously registered care-of address (which should be the valid care-of address in case of an attack) in addition to or instead of sending 505, 506 a binding acknowledgment to the mobile node's home address. Also this option would allow the mobile node to recognize the attack on its binding.

If the mobile node detects an attack on its binding, it may take countermeasures to for example repair the binding again. In the exemplary embodiment in FIG. 19 the mobile node performs a return routability procedure 509 including a home test 510 and a care-of test 511 so as to generate new cryptographic information. In one exemplary embodiment, the home test may include sending a home test-init message with a cookie to the correspondent node via the home network (i.e. home agent) and the correspondent node sending a response, a home test message including for example a home keygen token. The home test message is sent via the home agent to the mobile node. Similar thereto, the care-of test may for example include sending a care-of test-init message with a cookie to the correspondent node directly and the correspondent node sending a response, a care-of test message including for example a care-of keygen token.

Using the cryptographic information obtained from the return routability procedure, the mobile node and correspondent node may determine/generate 512, 513 a binding key used for authenticating a subsequent binding update. The steps 512, 513 may be optional. E.g. the return routability procedure could provide the mobile node and correspondent node with cryptographic information which may be directly used in authenticating subsequent messages.

Irrespective of the exact implementation of the return routability procedure 509, the cryptographic information obtained therefrom are subsequently used by the mobile terminal to authenticate the registration 514 of its correct care-of address at the correspondent node to thereby repair the binding and revoke the effect of the detected attack. Subsequently, the packets sent 515 to the mobile node now correctly registered care-of address will be routed to the mobile terminal again.

The retransmission window mentioned above may for example be defined as the window, in which binding acknowledgements can be received for binding update messages that were retransmitted. For instance, if the mobile node sends a binding update with sequence number 11 and no binding acknowledgement with sequence number 11 is received before the retransmission timer at the mobile node expires, the mobile node would send another binding update with a new sequence number (e.g., 12). It is now possible that neither the binding update nor the binding acknowledgement message with sequence number 11 was lost, but instead that they have been delayed by a time longer than the retransmission timer (e.g. due to temporary congestions in the network). In this case, the mobile node receives a delayed binding acknowledgement with a sequence number lower than the current sequence number. The retransmission window may be configured statically or dynamically, so that the mobile node does usually not receive a binding acknowledgement with a sequence number lower than the current sequence number minus the retransmission size. An attack may for example be detected, if a binding acknowledgement is received at the mobile node with a sequence number that is out of the retransmission window, e.g. higher or by a certain threshold lower than the current sequence number.

However, packet loss is a problem for this mechanism. If an attack is successful and binding acknowledgements are only sent as reply to binding update messages and those binding acknowledgements are lost, the attack cannot be detected by the mobile node. Various mechanisms can be used to accommodate such packet loss scenarios. One option would be that the mobile node sends an acknowledgement for binding acknowledgement messages, so that correspondent node is able to detect packet loss and re-send the binding acknowledgement messages.

In another embodiment according to the third aspect of the invention, the mobile node checks the correctness of the binding entry in the correspondent node by sending probe messages to the correspondent node, which require a reply from the correspondent node (e.g. similar to an ICMP echo request/response) whereby the response is to be directed to the mobile node's care-of address registered at the correspondent node. In one variation of the embodiment, the correspondent node always uses the care-of address registered in the binding cache as a destination for its response, irrespective of whether the probe messages are received via the mobile node's home network (i.e. from the home agent) or the mobile node directly. These probe messages could be sent once, periodically or occasionally, e.g. when no data has been received by the correspondent node for a certain amount of time. The probe messages may be tunneled over the home agent, so that they have mobile node's home address as source address and the correspondent node must use the binding cache entry for the reply. Another option would be to send the probe messages directly from the mobile node to the correspondent node. If no reply to the probe message(s) is received after multiple replies, the mobile node may interpret this as an indication for a successful attack.

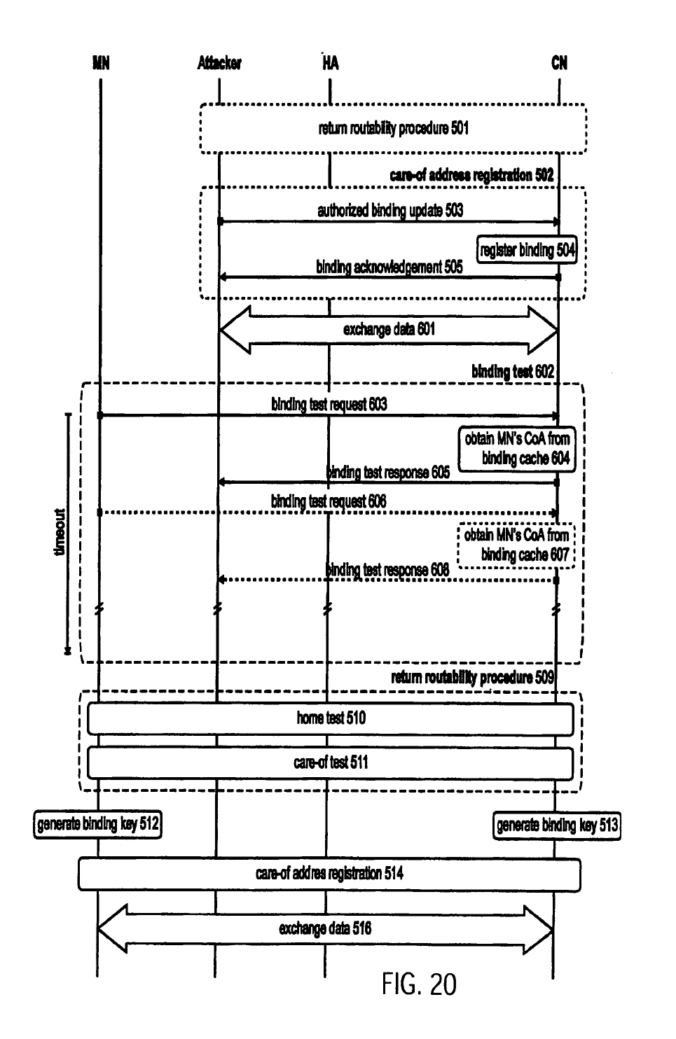

FIG. 20 shows an exemplary sequence of messages exchanged between an attacker, a mobile node, a correspondent node and a home agent allowing the mobile node to detect an attack on its binding at the correspondent node based on a binding test according to an exemplary embodiment according to the third aspect of the invention. For exemplary purposes it is assumed that mobile node and correspondent node use route optimization for exchanging data packets.

As in the example shown in FIG. 19, also in this embodiment according to the third aspect of the invention, it is assumed for exemplary purposes only that the attacker launches an address stealing or impersonation attack. Accordingly the attacker first performs a return routability procedure 501 and subsequently registers 502, 503, 504, 505 its address at the correspondent node. As these steps are similar to those of FIG. 19, it is referred to the description of FIG. 19 for further details. Accordingly, all data from the correspondent node destined to the spoofed mobile node's care-of address will be provided 601 to the attacker's address upon its registration as the new care-of address of the mobile node in the binding cache of the correspondent node.

It should be noted that unlike in FIG. 19, it is not required in this exemplary embodiment that the correspondent node does not need to send a binding update to the mobile node's home address or previously registered care-of address, as a binding test mechanism is used to detect an attacker. However, in another embodiment, the mechanisms for detecting an attacker based on binding acknowledgments and using a binding test could be advantageously used in combination as well.

Returning to the binding test 602 proposed in this embodiment according to the third aspect of the invention, same may for example be based on a request-response scheme, for example using a similar mechanism as an ICMP echo/response mechanism. The mobile node may send 603 a binding test request message to the correspondent node. In the example shown in FIG. 20, the binding test request is transmitted to the correspondent node directly. Optionally, the mobile node may reverse tunnel the binding test request to its home agent, which forwards the binding test request to the correspondent node. In any case, the correspondent node will respond to this request by sending 605 a binding test response message. This message is directed to the currently registered care-of address of the requesting mobile node, which is obtained 604 from the correspondent node's binding cache. Assuming that the mobile node's binding at the correspondent node has been spoofed by an attacker, the binding test response to the binding test request from the mobile terminal is destined to the spoofed care-of address, i.e. the attacker in this example.

Optionally, the mobile node could send more than one binding test request message to verify its binding cache entry at the correspondent node. This is illustrated by the dotted messages 606, 608 and dotted functional block 607 in FIG. 20.

The mobile node may start a timer upon for a binding test message and upon one or more binding request messages have timed out (i.e. no response has been received within a threshold time period), the mobile node may consider this circumstance as a corruption of its binding at the correspondent node. Hence, similar to the situation in FIG. 19 the mobile node may take appropriate countermeasures, e.g. by performing a full return routability test 509 including a home test 510 and a care-of test 511, optionally generating 512, 513 binding keys at mobile node and correspondent node and registering 514 the correct care-of address of the mobile node again to repair the spoofed binding.

In the embodiments described with respect to FIG. 20 above, it has been assumed for exemplary purposes that the binding test response is sent by the correspondent node in response to a corresponding request from the mobile node—i.e. is a solicited response message. In a further embodiment according to the third aspect of the invention, the correspondent node may send unsolicited alive messages. These alive messages could be for example sent y the correspondent node periodically or occasionally (e.g., when no data has been sent by the correspondent node to the mobile node for a certain amount of time) and are destined to the current care-of address of the mobile node registered in the binding cache of the correspondent node. In one exemplary embodiment, the unsolicited alive messages are binding acknowledgement messages. If no data and/or no unsolicited alive message(s) are received for multiple threshold time periods, the mobile node may interprets this as an indication for a successful attack. Essentially, the binding test using unsolicited alive messages is similar to the mechanism shown in FIG. 20. In contrast thereto, the mobile node does not send binding test requests (steps 603, 606) and may restart a timer upon having either received a data packet from the correspondent node destined to its care-of address or upon reception of an unsolicited alive message. Further, the binding test response messages 605, 608 may be considered unsolicited alive messages in this case.

The detection mechanisms according to the various embodiments according to the third aspect of the invention outlined above may be used in addition to existing binding procedures to make them more secure. For example, the new mechanisms could allow the mobile node to detect an on-path attack in the standard return routability procedure/route optimization mode or to cover unlikely attacks like spoofing cryptographically generated address addresses. In the latter case, an attacker would perform a brute-force attack to calculate a public key that generates an existing cryptographically generated address. Depending on the security parameter used for generating the cryptographically generated address, the effort needed for such a brute-force attack may be in realistic bounds. With the detection mechanisms proposed herein, such attack may be detected and actions can be triggered to revoke the effects.

Further, the detection mechanisms proposed herein may be also used to optimize the binding procedures (including a return routability procedure) in a way that does not prevent all attacks in the first place, but reduces signaling overhead and handover delay. If the mobile node detects an attack, it immediately undertakes some actions to revoke the effects of the attack.

Such actions could be to repair the binding cache entry at the correspondent node by initiating a new correspondent registration including a full return routability procedure as exemplified above.

Another additional or alternative countermeasure besides repairing a spoofed binding may be to inform the correspondent node about the attack. In response to the notification on an attack, the correspondent node may for example stop using route optimization for the mobile node and/or may block further binding update messages from certain addresses or prefixes. For example, if the attacker redirects the traffic to itself, the spoofed care-of address is actually a valid address of the attacker, so that the correspondent node is aware of the network prefix and address of the attacker.

To avoid that the attacker from spoofs or prevents the notification on an attack being reported to the correspondent node, one embodiment according to the third aspect of the invention relates to the mobile node securely informing the correspondent node about the attack. This may be for example implemented by the by sending a notification message that is signed by the mobile node with a new generated cryptographic information (e.g. binding key). Alternatively, if a trust relationship (or security association) between correspondent node and home agent exist, the mobile node also send the notification via the home agent to the correspondent node. The home agent may sign the message with a key which allows the correspondent node to verify whether the notification has been routed over the home agent. Since there is typically a security association provided between mobile node and home agent, this procedure may secure authenticity of the notification on the attack.

Another goal of the third aspect of the invention is to enable maintaining communication between mobile node and correspondent node throughout a session including one or more changes of the mobile node's care-of address and using route optimization also in cases where the home agent is (temporarily) not reachable. Especially in cases, where the home agent is required to participate in a return routability procedure to provide the mobile node with cryptographic information for authenticating a new binding, the outage of the mobile node's home agent may lead to an interruption or termination of a session/service.

Hence, another embodiment according to the third aspect of the invention relates to providing optimized procedures for an authorized care-of address registration that does not entirely depend on the reachability of a mobile node's home agent.

In one exemplary embodiment according to the third aspect of the invention improvements to the return routability procedure and the care-of address registration are proposed.

According to this embodiment according to the third aspect of the invention, the return routability procedure and subsequent care-of address registration may be enhanced so that home address tests may be omitted. Since a general omission of the home address test may allow for impersonation attacks in certain scenarios, some embodiments according to the third aspect of the invention described herein suggest performing an initial home address test. In a further embodiment according to the third aspect of the invention one or more of the different mechanisms for detecting a spoofed binding cache entry at the correspondent node may be used to detect a time shifting attack and revoke its effects.

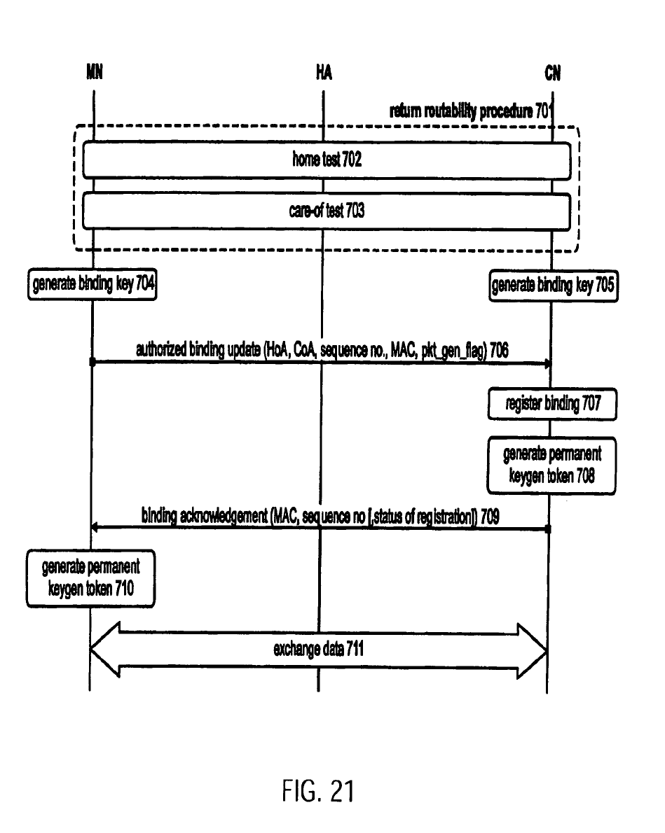

The improvements to the return routability procedure and subsequent care-of address registration according to one exemplary embodiment according to the third aspect of the invention will be outlined with respect to FIG. 21 in the following. FIG. 21 shows an exemplary sequence of messages exchanged between a mobile node, a correspondent node and a home agent according to an improved return routability procedure and subsequent care-of address registration according to an exemplary embodiment according to the third aspect of the invention.

Initially, the mobile node performs 701 the (full) return routability procedure including a home test 702 and a care-of test 703. In one example, this return routability procedure is similar to the one proposed in IETF RFC 3775. According to the cryptographic information exchanged in this procedure, the mobile node and the correspondent node may generate 704, 705 a binding key, respectively.

Subsequently, the mobile terminal starts the care-of address registration. The mobile terminal sends 706 an authorized binding update to the correspondent node. Generally, an authorized binding update may for example include the mobile node's home address to indicate for which home address (i.e. for which mobile node or interface thereof) a binding cache entry should be generated or changed in the binding cache of the correspondent node, and the new care-of address to be registered. Further, the authorized binding update may for example include a sequence number so as to allow an association of the binding update to a binding acknowledgment. To authenticate the sender of the binding update, the mobile node may for example include a message authentication code to the binding update, which is generated based on the cryptographic information obtained in the return routability procedure, e.g. the binding key.

If the mobile node wants to omit a home address test in subsequent return routability rounds (which may be referred to as “optimistic return routability rounds”), it may set a flag (pkt_gen_flag) in the authorized binding update that—when set—indicates to the correspondent node to generate a permanent keygen token to be used in subsequent optimistic return routability rounds. If the binding update message authentication code (MAC) is correct, the correspondent node may register 707 the care-of address of the mobile node indicated in the authorized binding update and may determine/calculate 708 a permanent home keygen token.

For example, the permanent keygen token may be calculated at least based on the home keygen token in the home test message. The home keygen token may be either used as a permanent keygen token. In this case, the home keygen token is reused in subsequent optimistic return routability rounds. The permanent keygen token may be referred to a permanent home keygen token in this case. Alternatively, the correspondent node may calculate the permanent token by other means. In one exemplary embodiment according to the third aspect of the invention the permanent keygen token is calculated as follows using a hash function (e.g. SHA1):

permanent keygen token=First(64,SHA1(Kbm|segno))

Please note that | denotes a concatenation of the binding key Kbm and the sequence number seqno in the binding update received/sent by the mobile node. First (x, . . . ) is a function extracting the first x bits from the result of the hash function SHA1 applied to the a concatenation of the binding key Kbm and the sequence number seqno. Please note that the binding key used in this function could be for example the home keygen token obtained from the home test of the return routability procedure, any other or combination of cryptographic information obtained from a return routability procedure including a home test. In one embodiment of the invention, the binding key Kbm is calculated as defined in IETF RFC 3755 mentioned previously herein.

In another embodiment according to the third aspect of the invention, the care-of keygen token may be included as part of the binding key. This may have the advantage is that an attacker must have received both, the initial home test message and the corresponding care-of test message to calculate the correct permanent keygen token. The permanent token may be stored in the binding cache entry for the mobile node in the correspondent node.

The correspondent node may further send 709 a binding acknowledgement back to the mobile node indicating the successful binding update. Subsequently, the mobile node calculates 710 and stores the permanent home keygen token in the same way the correspondent node did, so that both, mobile node and correspondent node have generated and stored corresponding permanent tokens. Both nodes may assign a finite lifetime to the token, which may be pre-determined or negotiated. Moreover, this lifetime may be significantly larger than 7 minutes.

Having successfully registered the new binding for the mobile node at the mobile node and the correspondent node may exchange 711 data packets using the updated care-of address of the mobile node.

Upon having generated a permanent token at mobile node and correspondent node as exemplified above, this permanent token may be utilized for subsequent care-of address registrations of the mobile node, or more specifically for authentication of subsequent binding updates transmitted from the mobile node. Subsequent registrations of a care-of address may thus no longer utilize a home-test. In some embodiments even no care-of test is used. This may for example reduce the signaling required for registering a care-of address of a mobile node at the correspondent node and/or allows for a care-of address registration and thus the use of route optimization even in case the home agent serving the mobile node (or more specifically, serving the mobile node for one or more of its interfaces) is down, e.g. due to failure, attack, network congestion, or the like.

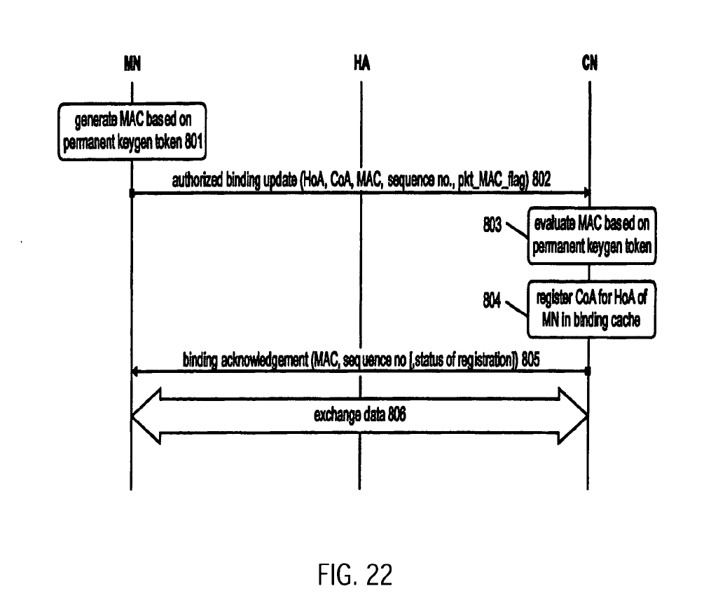

FIG. 22 shows a sequence of steps and messages exchanged between a mobile node and a correspondent node for registering a care-of address of the correspondent node according to an exemplary embodiment according to the third aspect of the invention where a permanent token is used for authentication. Upon having been assigned or generated a new care-of address by the mobile node, e.g. due to attaching to a new network or another administrative domain of an network using another prefix, the mobile node prepares for registering its new care-of address at the correspondent node. In this embodiment, no home test or care-of test is performed. Instead, the mobile node uses a permanent keygen token known to mobile node and correspondent node for authenticating the registration. Accordingly, the mobile node calculates 801 a message authentication code for inclusion to the binding update so as to authenticate the message content. Thereby the permanent keygen token is used to generate the message authentication code (MAC).

In one example, the message authentication code may be determined as follows:

MAC=First(96,HMAC_SHA1(permanent keygen token,(care-of address|correspondent node address|Binding Update)))

The message authentication code may thus be formed by the first 96 (or alternatively another number—e.g. 128, 64, 48, etc.—of) bits of the result of the hash function applied HMAC_SHA1 using the permanent keygen token as a key on a message formed by a concatenation of the (new) mobile node's care-of address to be registered, the correspondent node address and the binding update message.

Subsequently, an authorized binding update including the care-of address to register, the home address of the mobile node, and the MAC is transmitted 802 to the correspondent node. For informing the correspondent node that the binding update has been authorized using a permanent keygen token, the binding update may further comprise a flag (pkt_MAC_flag) that when set indicates to the correspondent node to evaluate 803 the MAC (i.e. to authenticate the binding update message) using the permanent keygen token. Further, the binding update may also comprise a sequence number (sequence no.) that could be for example used for associating a binding update to a binding acknowledgement.

Upon having authenticated 803 the binding update at the correspondent node, same may register 804 the care-of address in its binding cache. Further, the correspondent node may acknowledge the registration by sending 805 a binding acknowledgement to the mobile node. This binding acknowledgement may for example comprise a message authentication code generated by the correspondent node. The MAC in the binding acknowledgement may for example be determined in a similar fashion as the MAC for the binding update, taking into account that the hash function is applies over the binding acknowledgement message instead of the binding update message and (optionally) that the mobile node's care-of address or home address is used instead of the correspondent node's address.

Further, the binding acknowledgement may for example comprise a sequence number (e.g. equal to that in the binding update) to indicate to the mobile node for which binding update the acknowledgement is sent. Moreover, also optionally, the binding acknowledgement may further comprise an indication of the status of the registration, i.e. whether the binding update could be successfully authorized based on the permanent keygen token and/or the registration of the care-of address has been successful.

If the registration of the care-of address has been successful, mobile node and correspondent node continue 806 communication using route optimization.

One potential drawback of the procedure described with respect to FIG. 22 above is that the procedure may be susceptible to attacks especially an address stealing/Impersonation attack to eavesdrop or tamper the data destined to the mobile node, since no home test is performed. This may be particularly problematic if an attacker has eavesdropped the communication between mobile node and correspondent node and has thereby obtained knowledge of the permanent keygen token so that the attacker could spoof the mobile node's binding without requiring eavesdropping traffic destined to the mobile node's home address. Accordingly, according to another embodiment of the invention the procedure according to FIG. 22 may be improved by using one or more of the above described mechanisms for detecting a spoofed binding update.

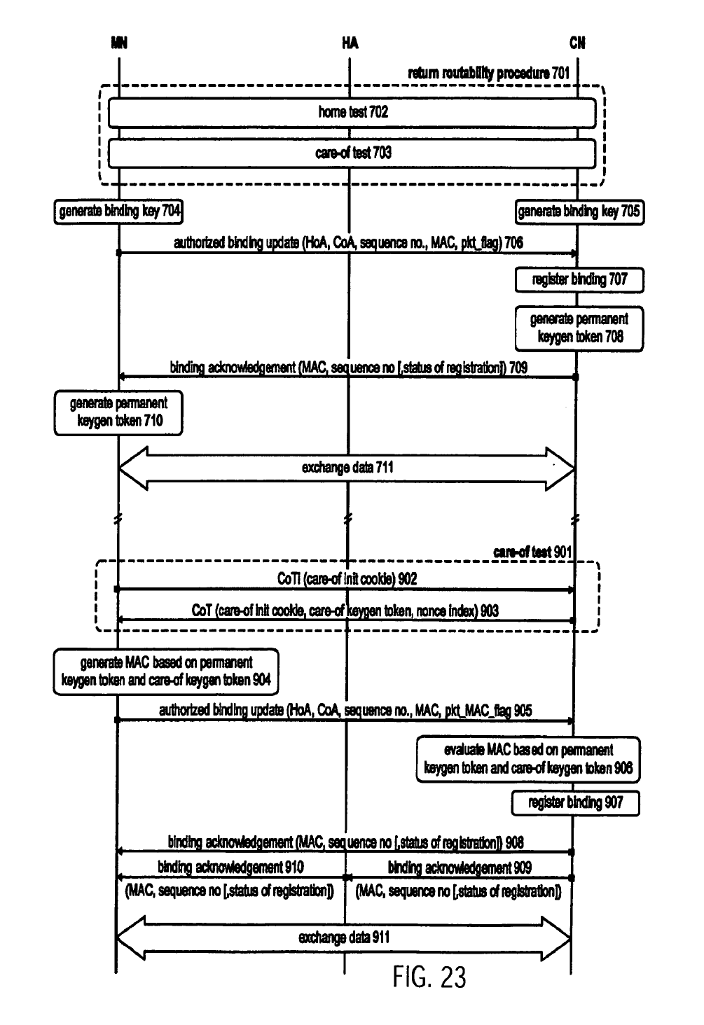

FIG. 23 exemplifies another sequence of steps and messages exchanged between a mobile node, home agent and a correspondent node for registering a care-of address of the correspondent node according to an exemplary embodiment according to the third aspect of the invention where a permanent token is used for authentication.

Similarly to FIG. 21 the mobile node first registers a care-of address at the correspondent node. A full return routability procedure 701 including a home test 702 and a care-of test 703 is performed, a binding key is generated 704, 705 for authenticating the subsequently sent 705 binding update. The correspondent node registers 707 the care-of address, and due to the pkt_flag being set generates 708 a permanent keygen token as explained previously herein. Also the mobile node generates 710 the permanent keygen token in response to the acknowledgment received 709 from the correspondent node.

Subsequently, when the mobile node is to register a new care-of address at the correspondent node the permanent keygen token may be used in authenticating the messages exchanged between mobile node and correspondent node. In this example, the mobile node and the correspondent node perform a care-of test 901. The mobile node sends 901 a care-of test init message, and receives 903 in response thereto the corresponding care-of test message. Thereby the mobile node is provided with a care-of keygen token (also known to the correspondent node).

In this example, the mobile node next generates 904 the message authentication code for authenticating its binding update to be sent. In this example, it may be assumed that the MAC is generated by the mobile terminal based in a binding key Kbm, which is in turn calculated based on the care-of keygen token of the just received care-of test message and the permanent keygen token obtained from the initial return routability procedure. Performing a care-of test in combination with the care-of address registration procedure and using a permanent keygen token and a care-of keygen token for authentication may be advantageous as flooding attacks may be prevented due to the care-of test.

For example, the MAC may for example be calculated as follows:

MAC=First(96,HMAC_SHA1(Kbm,(care-of address|correspondent node address|Binding Update message)))

This mechanism is similar to the one outlined above, except for using the binding key Kbm instead of the permanent keygen token. Again, taking the first 96 bits of the hash function serves exemplary purposes only.

The binding key Kbm in this example is generated using the care-of keygen token and the permanent keygen token. This could for example be realized as follows:

Kbm=SHA1(permanent keygen token|care-of keygen token)

Hence, the binding key may be the result of a cryptographic hash function applied to a concatenation of the permanent keygen token and the care-of keygen token.

The resulting message authentication code (MAC) may be included to the binding update as explained with respect to FIG. 22 above and the authorized binding update is sent 905 to the correspondent node. It should be noted that generally the MAC may also be signaled to the correspondent separately from the binding update, e.g. in a separate message. For example, an identifier common to this message and the binding update (e.g. a sequence number) may be used to associate the binding update and the message comprising the MAC for the binding update. Further, the MAC—when sent in a separate message—may be calculated not only based on the binding update but additionally on the separate message (e.g. by using a concatenation of the messages as an input to a hash function).

In order to indicate to the correspondent node that the permanent keygen token has been used for the calculation of the MAC the binding update may include a respective flag, pkt_MAC_flag, indicating the use of the permanent keygen token for the calculation of the MAC to the correspondent node. If the MAC is signaled separate from the binding update the flag would indicate that the correspondent node is to receive a separate message including the MAC for authenticating the binding update.

Similarly to the mobile node, if the flag is set, the correspondent node uses the permanent keygen token to calculate the binding key Kbm (if not already present) and verifies 906 the MAC in the binding update message. If the binding update is valid, the correspondent node registers 907 the care-of address in the binding update in its cache. Further, the correspondent node may send 908 a binding acknowledgement to the mobile node's new care-of address as explained previously. In this embodiment according to the third aspect of the invention the correspondent node (additionally) sends 909, 910 a binding acknowledgement message to the mobile node's home address and/or to the mobile node's old care-of address. Subsequently, the mobile node and the correspondent node may exchange 9011 data using the new registered care-of address.

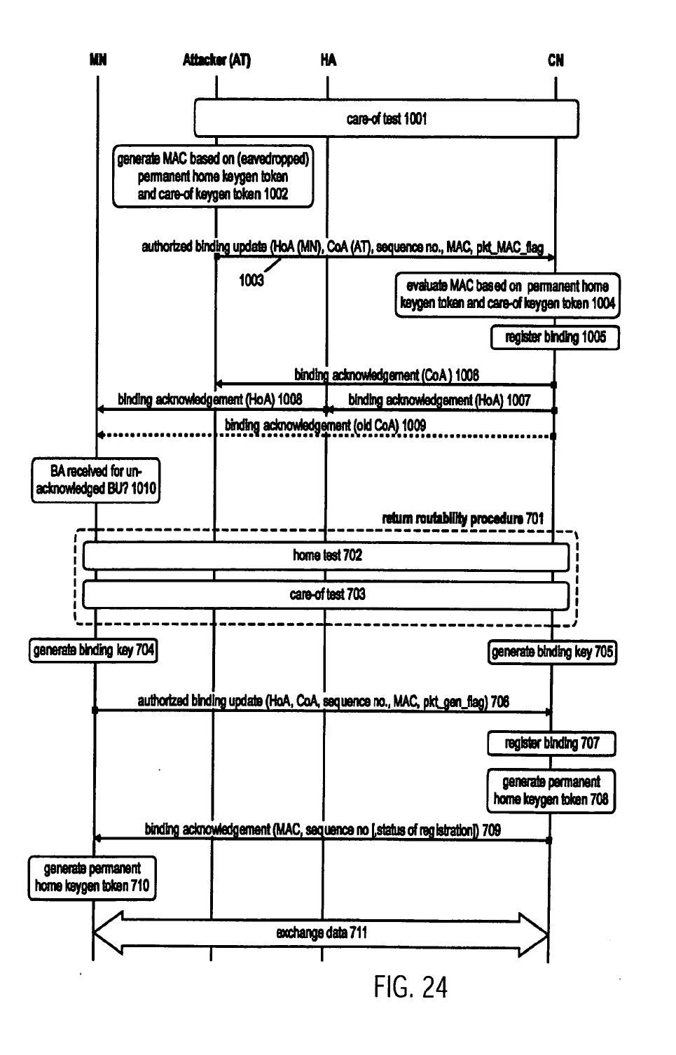

As will be outlined with respect to FIG. 24 below, any of the two latter binding acknowledgement messages (i.e. an acknowledgment destined to the mobile node's home address 909, 910 or an acknowledgement sent to the previously registered care-of address) sent by the corresponding node allow the mobile node to detect an attack.

FIG. 24 shows another sequence of steps and messages exchanged between a mobile node, attacker, home agent and a correspondent node according to an exemplary embodiment according to the third aspect of the invention where a permanent token is used for authentication and where a mobile node detects that the attacker has spoofed its binding cache entry the correspondent node. Thereby, the registration of a care-of address does not require a home test to be performed (optionally also the care-of test could be omitted as outlined previously).

First, it is assumed that the attacker has gained knowledge of a permanent keygen token or has successfully performed a spoofed care-of address registration for mobile node using a similar method as shown in FIG. 21 so that it possesses a valid home keygen token. Upon having optionally performed 1001 a care-of test with the correspondent node, the attacker generates 1002 a message authentication code based on the (eavesdropped) permanent keygen token and (optionally) the care-of keygen token from the care-of test. The attacker authenticates the binding update sent 1003 to the correspondent node by means of the generated MAC and sets the flag, pkt_MAC-flag, in the binding update to indicate to the correspondent node that the binding update comprises a MAC generated based on a permanent keygen token known to attacker (mobile node) and correspondent node.

The correspondent node evaluates 1004 the MAC and if the evaluation is successful, registers 1005 the care-of address indicated by the attacker in the binding cache. Further, the correspondent node may (optionally) send 1006 a binding acknowledgement to the new care-of address to confirm the binding. To allow the detection of attacks, the correspondent node sends 1007, 1008 a binding update to the home address of the mobile node for which the binding has been updated. Alternatively, or in addition to the binding acknowledgement destined to the mobile node's home address the correspondent node sends 1009 a binding acknowledgement to the care-of address that has been previously registered for the binding cache. This previously registered care-of address corresponds to the up-to-date mobile node's care-of address (if the binding has not been spoofed before).

In case of an impersonation attack, the attacker has sent a binding update message with mobile node's home address to register a care-of address where it is reachable, and the mobile node receives at least one binding acknowledgement message without having sent the corresponding binding update message. As outlined above, the mobile node may for example map 1010 the binding acknowledgement messages to binding update messages by the sequence numbers in the messages. More specifically, the mobile node may for example detect an attack, when a binding acknowledgement is received with a sequence number that is not in the retransmission window (i.e., higher or by a certain threshold lower than the sequence number) of the last binding update sent to this correspondent node. If the mobile node has detected an attack, it may for example immediately revoke the effects of the attack. In FIG. 24, the mobile node initiates a return routability procedure 701 including home test 702 and care-of test 703 and which repairs the binding (704, 705, 706, 707, 709) and may optionally initiate the generation of a new permanent keygen token (708, 710). After these steps that are similar to same of FIG. 21 the correspondent node will destine 711 the data to the correct care-of address of the mobile node.

In the following, a brief analysis the security properties of the optimizations suggested for return routability procedures and care-of address registration procedures will be discussed. As will be shown, same are comparable to the security properties of the standard return routability procedure/route optimization mode known from MIPv6 as provided In IETF RFC 3755.

Off-path attacks are not possible with the return routability procedure using a permanent keygen token as proposed according to some embodiments of the invention if an initial home address test is performed. Only time shifting attacks, i.e., where the attacker is on-path for some time and then moves off-path to continue the attack are possible.

The time shifting attack is more severe in optimistic return routability rounds, since only an initial home test/home test init exchange may be performed in case of optimistic return routability. Consequently, an attacker that is located on the home agent-correspondent node path at the time the mobile node performs the initial full return routability can eavesdrop the home test and can obtain the permanent home keygen token (depending on how the permanent token is calculated, the attacker may have to be located simultaneously on the mobile node-correspondent node path to eavesdrop the care-of test and obtain the care-of keygen token). After obtaining the permanent token, the attacker can move off-path and redirect traffic using optimistic return routability (as explained with respect to FIG. 24 above) given that the attacker must still be reachable at the claimed care-of address due to the care-of address test. However, the mobile node may detect this attack in case of using at least one of detections mechanisms discussed herein, e.g. the due to a received binding acknowledgement for a binding update that has not been sent by the mobile node. This may allow the mobile node to take countermeasures such as repairing the binding by performing a return routability procedure including a home test and a subsequent care-of registration.

Consequently, the attacker may not continue its attack off-path, because the permanent keygen token has changed and can only be obtained again by moving back on-path.

It may also happen that the attacker starts a return routability procedure including a home test and care-of test and a subsequent care-of address registration and generates a permanent keygen token while on the path between home agent and correspondent node. In this case the mobile node is not involved in the return routability and may even not notice it. Also, binding acknowledgements to the old care-of address in subsequent optimistic return routability rounds would not reach the mobile node, since the old care-of address has been assigned to the attacker. However, binding acknowledgements destined to the mobile node's home address may still reach the mobile node and may enable the mobile node to detect the attack.

A new threat that may be created by using no return routability procedure or only a care-of test prior to care-of address registration may be that the attacker blocks return routability messages so that the mobile node is not able to repair the binding after a successful attack. To mitigate this threat, another embodiment according to the third aspect of the invention suggests that the home test messages (HoTi/HoT) and all signaling messages between mobile node and home agent are encrypted (e.g. using IPsec), so that an attacker can only block all or none of those messages. Since blocking binding acknowledgement messages and IPsec messages from the home agent can be detected by the mobile node (e.g. by means of a IPsec Dead Peer Detection), a mobile node in the process of repairing a binding can interpret this as an indication for blocking return routability messages.

In this case, the mobile node may for example send a message to the correspondent node that asks the correspondent node to require the use return routability procedures with home test and care-of test for generating cryptographic information for authentication of a subsequent care-of address registration. This notification sent to the correspondent node may for example be signed with cryptographic information obtained from a previous return routability procedure performed by mobile node and correspondent node that comprises home test and care-of test (for example a previously generated binding key).

Another potential problem that could be encountered is the attacker continuously performing attacks. In this case a large amount of traffic could be redirected even if the mobile node would continuously detect and repair the binding at the correspondent node. One option for mitigating continuous attack according to an embodiment according to the third aspect of the invention may be that the mobile node notifies the correspondent node on the continuous attacks. Such notification may for example be signed with cryptographic information obtained from a previous return routability procedure performed by mobile node and correspondent node that comprises home test and care-of test as mentioned above. The correspondent node may for example maintain a black list of care-of address(es) or care-of address prefixes for which return routability must include a home test and care-of test.

Optimistic return routability rounds may require some additional state information at the correspondent node such as e.g. the permanent keygen token, the maintenance of a black list, etc. However, this state is first established after an authorized binding update has been received by the correspondent node. An attacker might mount a denial of service attack by sending many bogus binding updates with random home addresses and care-of addresses to exhaust the memory of the correspondent node. To mitigate this attack, the correspondent node may for example limit the amount of resources that it uses for processing binding updates.

Reflection attacks with amplification are also not possible, since a victim never receives more messages (even when considering the additional binding acknowledgements) than the attacker has sent.

Another potential drawback of the return routability procedures already discussed above is that they may require participation of the home agent. For example for MIPv6, this means that route optimized communication is not possible, if the mobile node's home agent is down (even though the home agent would not be on the data path of route optimized traffic).

The proposed return routability procedures omitting the home test may in principle get rid of the dependency on the home agent. However, in order to make return routability procedures omitting the home test and subsequent care-of registration secure it is proposes in some embodiments to use mechanisms to detect attacks on a mobile node's binding such as sending a binding acknowledgement to the mobile node's home address. However, binding acknowledgement messages to mobile node's home address cannot reach the mobile node anymore if the home agent is down and hence the mobile node cannot detect address stealing/impersonation attacks during its home agent's down time. This may be a severe threat as the an attacker may for example mount denial of service attacks and force an home agent to go down, or the attacker could monitor home agents and wait with an attack until the home agent becomes unreachable for whatever reason.

One countermeasure to this threat according to an exemplary embodiment according to the third aspect of the invention is that the correspondent node sends a binding acknowledgement to the mobile node's old care-of address (i.e. the care-of address previously registered for the mobile node's home address). The correspondent node may either always direct a binding acknowledgement to the mobile node's old care-of address or only in situations where the mobile node's home agent is down.

Another issue might be how correspondent node and mobile node know that the home agent is down. One option is that mobile node detects that the home agent is not reachable based on missing binding acknowledgement messages from the home agent after the mobile node has sent binding update messages. Another option is to detect the outage of the hoe agent using IPsec Dead Peer Detection (DPD), if an IPsec security association exists between mobile node and home agent.

A further option may be to introduce a new periodic message exchange (e.g. ICMP echo request/reply messages) for this purpose. After the mobile node has detected that the home agent is down, the mobile node may inform the correspondent node on the home agent being down by means of a notification message. This message may for example be signed with cryptographic information obtained from a previous return routability procedure performed by mobile node and correspondent node that comprises home test and care-of test (for example a previously generated binding key). In one example, such notification may be included to a binding update message—e.g. by introducing a new flag to the binding update that when being set indicates that the home agent is down (“home agent down” flag).

To prevent an attacker from sending such spoofed notification to the correspondent node, the correspondent node may for example verify that the signature of the notification is valid and that the notification has been sent from the currently registered care-of address of the mobile node. Further, the correspondent node may optionally verify that the home agent is really down, e.g. by sending a request message (e.g. ICMP echo request) to mobile node's home address. If no reply is received after multiple tries, the correspondent node may conclude that the home agent is indeed down.

In case the correspondent node is informed on the home agent of a mobile node being down (and, optionally, upon having confirmed the notification) the correspondent node may for example store this information and switches to a “home agent down mode” where the home test may be skipped and the an acknowledgment of a binding update is sent to the new registered and the previously registered care-of address. Further, the binding update messages may be authorized using a permanent keygen token and optionally cryptographic information obtained from a care-of address test, i.e. no home address test is performed. The permanent keygen token may be for example calculated as described above or may be generated based on or equivalent to the home keygen token of the last successful home address test before the home agent went down.

Consequently, communication between mobile node and correspondent node using route optimization may continue even if the home agent is going down.

In a further embodiment according to the third aspect of the invention, the correspondent node and/or mobile node may periodically check whether the home agent is still down, e.g. by sending home agent down probe messages to the mobile node's home address (note that the home agent address may not be known by the correspondent node). If the home agent is up again, the correspondent node may send binding acknowledgements via the home agent again in response to an authorized binding update.

To mitigate the problem that an attacker can block the home agent down probe messages in order to cheat the correspondent node that the mobile node's home agent is down although it is not, the home agent may for example intercept the probe messages sent by correspondent node and may reply to them immediately (instead of forwarding them to the mobile node). This may prevent an attacker on the mobile node-home agent path to block those messages.

The mechanism for detecting attacks on a mobile node's binding at a corresponding node as well as the improvements to return routability procedures and care-of address registration procedures as proposed in the various embodiments according to the third aspect of the invention described herein may be advantageously used for in MIPv6. However, the principles and ideas outlined herein may also be applied to any protocol that registers bindings between addresses at a network entity and sends acknowledgement messages upon registration messages, e.g., mobike, HIP and their derivates.

In another embodiment according to the third aspect of the invention a mobile node that receives a care-of test message from another node without having sent corresponding care-of test init (e.g. this could be detected based on the care-of init cookie) may also use this circumstance as an indication of an attack on its binding at the node and may take appropriate countermeasures as outlined herein. Similarly, a mobile node receiving a home test message without having sent corresponding home test init may consider this event as an indication for an attempt to spoof binding update.

Another embodiment of the different aspects of the invention relates to the implementation of the above described various embodiments using hardware and software. It is recognized that the various embodiments of the invention according to the various aspects may be implemented or performed using computing devices (processors). A computing device or processor may for example be general purpose processors, digital signal processors (DSP), application specific integrated circuits (ASIC), field programmable gate arrays (FPGA) or other programmable logic devices, etc. The various embodiments of the invention may also be performed or embodied by a combination of these devices.

Further, the embodiments of the invention according to the various aspects may also be implemented by means of software modules, which are executed by a processor or directly in hardware. Also a combination of software modules and a hardware implementation may be possible. The software modules may be stored on any kind of computer readable storage media, for example RAM, EPROM, EEPROM, flash memory, registers, hard disks, CD-ROM, DVD, etc.

In the previous paragraphs various embodiments of the invention and variations thereof have been described. It would be appreciated by a person skilled in the art that numerous variations and/or modifications may be made to the present invention as shown in the specific embodiments without departing from the spirit or scope of the invention as broadly described.

1-154. (canceled)

155. A method for managing the mobility of a mobile node at a mobile anchor point, said mobile node moving between a first network and a second network, wherein said first network uses a mobile node-based mobility management scheme for managing the mobility of the mobile node, and said second network uses a network-based mobility management scheme for managing the mobility of the mobile node, said mobile anchor point implementing both the mobile node-based mobility management scheme and the network-based mobility management scheme, said method comprising the following steps executed by the mobile anchor point:
receiving a first message from the mobile node on a first location of the mobile node in the first network, where the mobile node has a first IP address,
receiving a second message from a network element in the second network on a second location of the mobile node in the second network, where the mobile node has a second IP address,
transmitting a binding request message to at least one of the first and second IP address of the mobile node,
receiving a response message for the at least one of the first and second IP address, and
determining which one of the first and second IP address is a current IP address of the mobile node based on the received response message.

156. A method for managing the mobility of a mobile node at a mobile anchor point, said mobile node moving between a first network and a second network, wherein said first and second network use a network-based mobility management scheme for managing the mobility of the mobile node, said mobile anchor point implementing the network-based mobility management scheme, said method comprising the following steps executed by the mobile anchor point:
receiving a first message from a first network element in the first network on a first location of the mobile node in the first network, where the mobile node has a first IP address,
receiving a second message from a second network element in the second network on a second location of the mobile node in the second network, where the mobile node has a second IP address,
transmitting a binding request message to at least one of the first and second IP address of the mobile node,
receiving a response message for the at least one of the first and second IP address, and
determining which one of the first and second IP address is a current IP address of the mobile node based on the received response message.

157. The method according to claim 155, wherein the at least one of the first and second IP address is determined as the current IP address of the mobile node if the received response message is a positive response message for the at least one of the first and second IP address.

158. The method according to claim 157, wherein the positive response message is a binding update message having a non-zero lifetime.

159. The method according to claim 155, wherein the other one of the at least one of the first and second IP address is determined as the current IP address of the mobile node if the received response message is a negative response message for the at least one of the first and second IP address.

160. The method according to claim 155, further comprising measuring a time interval between the reception of the first and second message, wherein said binding request message is transmitted to at least one of the first and second IP address of the mobile node when the measured time interval is smaller than a predetermined time duration.

161. The method according to claim 160, wherein the predetermined time duration is larger than or equal to a minimum time duration necessary in a handover of the mobile node between the first and second network.

162. The method according to claim 155, wherein the first IP address is a first care-of-address configured for the mobile node in the first network, and the second IP address is a second care-of-address configured for the mobile node in the second network.

163. The method according to claim 155, further comprising calculating a time difference between a first time of arrival of the first message at the mobile anchor point and a second time of arrival of the second message at the mobile anchor point.

164. The method according to claim 155, wherein the mobile anchor point is a home agent for the mobile node, said method further comprising:
storing the IP address of the earliest received one of the first and second message, preferentially in a binding cache entry of the home agent, and
storing the IP address of the latest received one of the first and second message until reception of the binding update message.

165. The method according to claim 164, wherein the binding request message is transmitted to the stored IP address of the earliest received one of the first and second message and to the stored IP address of the latest received one of the first and second message.

166. The method according to claim 164, further comprising deleting the stored IP address of the latest received one of the first and second message upon reception of the binding update message, and
updating the stored IP address of the earliest received one of the first and second message by the one of the first and second IP address contained in the received binding update message.

167. The method according to claim 166, further comprising updating a timer lifetime of the binding cache entry when the one of the first and second IP address contained in the received binding update message corresponds to the stored IP address of the earliest received one of the first and second message.

168. The method according to claim 155, wherein the binding request message is at least one of a binding acknowledgment message, a care-of-address test initiation message or an Internet Control Message Protocol message.

169. The method according to claim 155, wherein the binding request message is a binding acknowledgment message, and said method further comprises setting a refresh advise option of the binding acknowledgment message to zero before transmitting the binding acknowledgment message.

170. The method according to claim 169, further comprising transmitting, by the mobile node or the network element, a binding update to the mobile anchor point upon reception of a binding request message with a refresh advise option set to zero.

171. The method according to claim 155, further comprising:
receiving, by the network element, the binding request message from the mobile anchor point,
checking, by the network element, an attachment of the mobile node to the network element, and
transmitting, by the network element, a binding update to the mobile anchor point if the mobile node is attached to the network element, or discarding, by the network element, the binding request message if the mobile node is not attached to the network element.

172. The method according to claim 155, further comprising:
receiving, by the network element, the binding request message from the mobile anchor point,
checking, by the network element, an attachment of the mobile node to the network element, and
transmitting, by the network element, a binding update having a lifetime longer than zero if the mobile node is attached to the network element, or a binding update having a lifetime equal to zero if the mobile node is not attached to the network element.

173. The method according to claim 171, wherein the checking step comprises transmitting, by the network element, at least one of a layer 2 polling message or a neighbour solicitation message to the mobile node.

174. The method according to claim 155, further comprising:
receiving, by the mobile anchor point, a binding de-registration message from the mobile node or the network element for one of the first and second IP address of the mobile node, and
determining, by the mobile anchor point, that the other one of the first and second IP address of the mobile node is the current IP address of the mobile node upon reception of the binding de-registration message.

175. The method according to claim 174, further comprising stopping the transmission of the binding request message upon reception of the binding de-registration message.

176. The method according to claim 174, wherein, when the binding de-registration message for one of the first and second IP address of the mobile node is received after the transmission of the binding request message and before the reception of a response message, said method further comprises determining that the other one of the first and second IP address of the mobile node is the current IP address of the mobile node without waiting for the reception of the response message.

177. A mobile anchor point for managing the mobility of a mobile node, said mobile node moving between a first network and a second network, wherein said first network uses a mobile node-based mobility management scheme for managing the mobility of the mobile node, and said second network uses a network-based mobility management scheme for managing the mobility of the mobile node, said mobile anchor point implementing both the mobile node-based mobility management scheme and the network-based mobility management scheme, and said mobile anchor point comprising:
a receiving section that receives a first message from the mobile node on a first location of the mobile node in the first network, where the mobile node has a first IP address, and a second message from a network element in the second network on a second location of the mobile node in the second network, where the mobile node has a second IP address, and
a transmitting section that transmits a binding request message to at least one of the first and second IP address of the mobile node,
wherein said receiving section is adapted to receive a response message for the at least one of the first and second IP address, and
said mobile anchor point further comprises a determining section that determines which one of the first and second IP address is a current IP address of the mobile node based on the received response message.

178. A mobile anchor point for managing the mobility of a mobile node, said mobile node moving between a first network and a second network, wherein said first and second network use a network-based mobility management scheme for managing the mobility of the mobile node, said mobile anchor point implementing the network-based mobility management scheme, and said mobile anchor point comprising:
a receiving section that receives a first message from a first network element in the first network on a first location of the mobile node in the first network, where the mobile node has a first IP address, and a second message from a second network element in the second network on a second location of the mobile node in the second network, where the mobile node has a second IP address, and
a transmitting section that transmits a binding request message to at least one of the first and second IP address of the mobile node,
wherein said receiving section is adapted to receive a response message for the at least one of the first and second IP address, and
said mobile anchor point further comprises a determining section that determines which one of the first and second IP address is a current IP address of the mobile node based on the received response message.

179. The mobile anchor point according to claim 177, wherein said determining section is adapted to determine the at least one of the first and second IP address as the current IP address of the mobile node if the received response message is a positive response message for the at least one of the first and second IP address.

180. The mobile anchor point according to claim 179, wherein the positive response message is a binding update message having a non-zero lifetime.

181. The mobile anchor point according to claim 177, wherein said determining section is adapted to determine the other one of the at least one of the first and second IP address as the current IP address of the mobile node if the received response message is a negative response message for the at least one of the first and second IP address.

182. The mobile anchor point according to claim 177, further comprising a measuring section that measures a time interval between the reception of the first and second message,
wherein said transmitting section is adapted to transmit the binding request message to at least one of the first and second IP address of the mobile node when the measured time interval is smaller than a predetermined time duration.

183. The mobile anchor point according to claim 177, wherein said receiving section is adapted to receive a binding de-registration message from the mobile node or the network element for one of the first and second IP address of the mobile node, and
said determining section is adapted to determine that the other one of the first and second IP address of the mobile node is the current IP address of the mobile node upon reception of the binding de-registration message.

184. The mobile anchor point according to claim 183, wherein said mobile anchor point is adapted to stop the transmission of the binding request message upon reception of the binding de-registration message.

185. The mobile anchor point according to claim 183, wherein, when the binding de-registration message for one of the first and second IP address of the mobile node is received after the transmission of the binding request message and before the reception of a response message, said determining section is adapted to determine that the other one of the first and second IP address of the mobile node is the current IP address of the mobile node without waiting for the reception of the response message.

186. A mobile node moving between a first network and a second network, wherein said first network uses a mobile node-based mobility management scheme for managing the mobility of the mobile node, and said second network uses a network-based mobility management scheme for managing the mobility of the mobile node, said mobile node comprising:
a transmitting section that transmits to a mobile anchor point for the mobile node a message on a location of the mobile node in the first network, where the mobile node has a first IP address, and
a receiving section that receives from the mobile anchor point a binding request message for the first IP address of the mobile node,
wherein said transmitting section is adapted to transmit to the mobile anchor point a response message to the received binding request message.

187. The mobile node according to claim 186, wherein said transmitting section is adapted to transmit a binding update to the mobile anchor point upon reception of a binding request message with a refresh advise option set to zero.

188. A network element in a network using a network-based mobility management scheme for managing the mobility of a mobile node, said network element comprising:
a transmitting section that transmits to a mobile anchor point for the mobile node a message on a location of the mobile in the network, where the mobile node has an IP address, and
a receiving section that receives from the mobile anchor point a binding request message for the IP address of the mobile node,
wherein said transmitting section is adapted to transmit to the mobile anchor point a response message to the received binding request message.

189. The network element according to claim 188, wherein said transmitting section is adapted to transmit a binding update to the mobile anchor point upon reception of a binding request message with a refresh advise option set to zero.

190. The network element according to claim 188, further comprising a checking section that checks an attachment of the mobile node to the network element,
wherein said network element is adapted to transmit a binding update to the mobile anchor point if the mobile node is attached to the network element, or to discard the binding request message if the mobile node is not attached to the network element.

191. The network element according to claim 188, further comprising a checking section that checks an attachment of the mobile node to the network element,
wherein said network element is adapted to transmit a binding update having a lifetime longer than zero if the mobile node is attached to the network element, or a binding update having a lifetime equal to zero if the mobile node is not attached to the network element.

192. The network element according to claim 190, wherein the checking section is adapted to transmit at least one of a layer 2 polling message or a neighbour solicitation message to the mobile node.
